(19) United States
(12) Patent Application Publication
(10) Pub. No.: US 2008/0134276 A1
(43) Pub. Date: Jun. 5, 2008

(54) Receiver and aspects thereof

(76) Inventors: Martin Orrell, Bedfordshire (GB); Antony Rix, Cambridgeshire (GB); Coreena Fiona, Anne Lofting, London (GB)

Correspondence Address: NIXON & VANDERHYE, PC, 901 NORTH GLEBE ROAD, 11TH FLOOR, ARLINGTON, VA, 22203, US

(21) Appl. No.: 11/822,018

(22) Filed: Jun. 29, 2007

(30) Foreign Application Priority Data
Jun. 30, 2006 (GB) 0613053.8
Jul. 13, 2006 (GB) 0613947.1

(51) Int. Cl. H04N 7/173

(52) U.S. Cl. 725/132

(57) ABSTRACT

A method of provisioning a mobile communications device with a digital audio broadcast (DAB) application configured to run on the mobile communications device, the method comprising: generating a request for at least one component of the DAB application using a communications application of said mobile communications device; communicating the request over a bi-directional wireless communications network to a remote server; receiving the request at the remote server; processing the request to identify one or more DAB application components suitable for download to the mobile communications device; downloading said one or more DAB application components to the mobile communications device over said bi-directional wireless communications network; and installing said one or more DAB application components onto said mobile communications devices.

The present invention relates to a digital broadcast receiver and related aspects. In particular, but not exclusively to a receiver for a mobile communications device arranged to play and display digitally broadcast data, audio and video signals. The signals are partially decoded by receiver hardware (i.e., circuitry controlled by software) and partially decoded by software (i.e., a receiver application) supported by the operating system of its host mobile communications device. The receiver software application shares certain resources of the host mobile communications device with other applications supported by the operating system of the host device.

Digital broadcasting systems are well known in the art. A digital broadcasting system transmits digital broadcast data, audio, and video signals in accordance with certain agreed standards (e.g. standardised data formats and transmission protocols). This enables equipment manufacturers to develop appropriate devices for receiving and playing the signals to consumers of the broadcast digital services. Mobile digital television (MDTV) standards and technologies are evolving and currently established and emerging MDTV technologies known to those of ordinary skill in the art include: digital audio broadcast (DAB)/digital media broadcast (DMB), digital video broadcast (DVB), DVB-T (terrestrial), DVB-H (handheld), DVB-SH, MediaFLO, T-DMB, DAB-IP, TMMB, ISDB-T, CMMB, and DMBT.

Digital Audio Broadcast (DAB) is a standard for broadcasting digital audio signals and video signals. The standards for digital video broadcast (DVB) signals differ slightly from the standards for DAB signals which also carry video content. There are two well-known techniques for broadcasting video using the DAB standards. One is the Digital Multimedia Broadcast standard (DMB) and the other is the “Motion PAD” (M-PAD) which essentially supplements the DAB audio programme. A particular DMB standard is T-DMB, which uses H264/AAC or H264/BSAC encoded video/audio carried over a MPEG-2 transport stream; another is DAB IP multicast.

Technologies associated with current and future transmission standards can differ considerably and affect several elements of a MDTV system such as the physical characteristics of the transmitted signals, the architecture of the content distribution system (for example, the head-end and whether and how an up-link from a receiving device is supported), the types of encoding schemes for transmission as well as content encoding and authentication. Examples of different physical transmission features include signal polarisation (Media-FLO systems use circular polarisation for example), modulation as well as differing spectrum bands: VHF (170 MHz to 240 MHz), UHF (470 MHz to 860 MHz), and at least two sections of the “L” band (variable depending on location between the UHF and “S” band) and the “S” band (2170 MHz to 220 MHz) for satellite broadcasting.

A known problem in the field is that as new standards evolve equipment comprising older technology may not be capable of correctly processing (i.e., receiving, decoding and/or storing/playing) a digital signal according to the new standard.

This can slow the rate at which new technology is made available to the public as effectively a technology bottleneck is created. New services cannot be deployed until new equipment is available to enable users to receive the new services. Equipment manufacturers are reluctant to redesign their equipment to receive the new services unless it is likely that users are going to want the new services and so create a demand for the new equipment.

MDTV presents additional technical challenges due to the variability of the mobile environment and also due to the requirements for portability which affect the mobile receiving devices. MDTV receivers may be incorporated into mobile host devices offering alternative modes of communication and/or processor functionality such as mobile communications handsets, personal digital assistant type devices (handset computers) and/or laptop (portable) computers. For example, the heat output, size, weight, and stability and robustness in a range of environmental conditions are all factors which can vary between different types of host devices and which can create additional problems. In addition, some host devices in which the MDTV receiver is provider have limited resources such as power (electrical energy), the availability and power of computer processing, electronic storage (e.g. flash memory, ROM, RAM etc), and some have limited display capabilities such as, for example, screen size, colour resolution and/or aspect ratio. The changing mobile environment can affect the reception of signals in terms of the quality of service as well as issues such as availability if a service is offered with only limited coverage. Communications networks are territorial and physical transmission parameters can change if a user of a mobile communications device crossed over a network boundary, requiring handover techniques.

It is known in the art that software radio technology enables radio transceiver components to be reconfigured. A software radio is a transceiver whose communication functions are realized as programs running on a suitable processor. A software defined radio (SDR) device (also known as a cognitive radio device) is a flexible reconfigurable radio communications device comprising reconfigurable hardware which is upgraded using software and/or in which functional changes can be implemented purely by changing the software.

By integrating radio functionality using software and leaving the hardware unchanged it is in addition possible to interface third party software applications into the basic radio. SDR receivers are already known in the art which can decode two audio and/or video and/or data services simultaneously. Cognitive radio CR is a type of SDR which reconfigures itself according to its sensed environment and it is also know for CRs to operate autonomously to exchange information with other devices in a communications network.

Known SDRs are multi-mode (i.e., multi-frequency band and/or multi-standards), multiservice and/or multi-channel systems (which support two or more independent transmission and reception channels at the same time). Transceiver (re-)configuration is possible at the point of commissioning the transceiver design, when a transceiver is switched off, dynamically on a per call basis without any downtime (which conventionally means only the front end digital base-band processing system can be rebooted), and even during a call on a per time-slot basis. Conventionally, a software-defined radio transceiver is (re-)configurable via control bus which provides the various SDR components which appropriate control parameters (such SDRs are known as Parameter Controlled SDRs or PaC-SDRs for short).

It is know in the prior art to reconfigure software radios either at the fabrication stage or after deployment. However, a problem exists when a device has been deployed in that the device may be required for use by a user not just for viewing MDTV associated data but for other applications, for example, telecommunications applications or as a diary/scheduling device.

European patent application EP 1670 158 in the name of Broadcom Corporation entitled “Method and System for receiving information via broadcast and cellular communication paths at a mobile terminal without service control” describes a mobile terminal which switches between reception of broadcast information via a VHF/UHF broadcast communication path and cellular information comprising voice and data based on a preference indicated at the mobile terminal which can be indicated via a software controlled interface and/or user-controlled interface.

International Patent Application WO 97/13336 in the name of OY Nokia AB entitled “Handling of Program Files in a Digital Broadcast System” describes how a special program guide file is generated at the transmitting end of a DAB system which contains a large amount of information intended for the application software of the receiver, invisible to the user such as hidden text, instructions, algorithms.

The invention seeks to provide an improvement to the way of data is received and processed by the receiver of a DAB radio module. For example, in one embodiment of the invention, data comprising reconfiguration information for the DAB module such as, for example, an upgrade to receiver software or an electronic programme guide application is received by a DAB receiver according to the invention in a way which a user of the communications device hosting the DAB receiver can control. In this way, the invention seeks to reduce the impact of a reconfiguration process on the components of the DAB module unaffected by the reconfiguration process and/or the other components of the communications device hosting DAB module (which may be a removeable component of such a device or an integral part of such a device). In this way, for example, the energy of a battery operated mobile device may need to be reserved for another application/use (e.g. for making a telephone call) and/or it may be preferable if large data files are only downloaded to the device when a high bandwidth connection is available.

A digital television broadcast receiver (such as a DAB receiver) according to the invention further comprises a multiplexer which remultiplexes a plurality of sub-channels extracted from one or more received digitally broadcast television ensemble(s) by the receiver components. This enables the digital television receiver decoder components which decode the content from the received sub-channels to operate on a plurality of sub-channels at the same time. This enables a user to watch a particular content channel whilst other content is being processed in background by the processor of the host device for the digital television receiver. A user is able to control which sub-channels are re-multiplexed for viewing by providing appropriate signalling and control information to the multiplexer component and/or the demultiplexor component of the receiver. In this way, a user can, for example, watch a particular channel whilst data is decoded in background from another sub-channel, which may or may not be from the same ensemble. This allows an electronic programme guide, for example, to be populated with data for a range of different services which may be carried by sub-channels in signals having physical characteristics. The invention also seeks to allow reconfiguration of hardware associated with receiver components for other signals whilst other receiver components are used to provide output for a signal with differing hardware requirements.

The invention also enables processing of electronic programme guide information to enable this information to be displayed more rapidly when requested by a user, and to enable the electronic programme guide to be updated in a manner which utilises the resources of a mobile communications device more efficiently.

### SUMMARY STATEMENTS OF THE INVENTION

The aspects of the invention and preferred embodiments are as set out below and as set out in the accompanying independent and dependent claims respectively. The claims are hereby incorporated into the description as aspects and embodiments of the invention, and may be combined with each other and with other aspects, embodiments and features recited in the description in any appropriate manner known to those of ordinary skill in the art.

One aspect of the invention seeks to provide a method of provisioning a mobile communications device with a tuneable receiver for digitally broadcast signals, the receiver comprising a receiver application and receiver circuitry, the receiver application being configured to run on an operating system of the mobile communications device, the method comprising:
generating a request for at least one component of the receiver application;
communicating the request over a communications link to a remote server;
receiving the request at the remote server;
processing the request to identify one or more receiver application components suitable for the mobile communications device;
downloading said one or more receiver application components; and
installing said one or more receiver application components onto said mobile communications device to provide a functional receiver application on said mobile communications device, whereby receiver circuitry integrated into said mobile communications device is arranged to interface with said receiver application to provide a tuneable receiver for digitally broadcast signals

In one embodiment, said request is communicated to the remote server by the mobile communications device.

In one embodiment, said request is communicated to the remote server by another device.

In one embodiment, said downloading step downloads said one or more DAB application components to said mobile communications device.

In one embodiment, said downloading step downloads said one or more receiver application components to another device, said downloaded application components being arranged for installation on said mobile communications device when connected to said other device.

In one embodiment, said step of installing said one or more receiver application components modifies the decoding process provided by a decoder implemented using said receiver application.

In one embodiment, said modification to the decoding process enables said DAB application to decode signals provided according to a different source data encoding or transport protocol than said receiver application was configured to decode prior to said downloaded receiver application components being installed on said mobile communications device.

In one embodiment, the decoding process operates on a received bearer sub-channel, whereby said receiver application is arranged to output said bearer content to a rendering device for a display of said mobile communications device.

In one embodiment, said rendering device is further arranged to render a graphical user interface for the operating system of said mobile communications device.

In one embodiment, said step of installing one or more receiver application components enables said mobile communication device to perform one or more of the following functions:
display signals of a higher definition than the definition displayed prior to said downloaded receiver application components being installed on said mobile communications device; and/or
play a signal having a different codec to a codec playable prior to said downloaded application component being installed on said mobile communications device; and/or
implement a new conditional access scheme for receiving digitally broadcast signals.

In one embodiment, said method of installing one or more receiver application components further comprises connecting said mobile communications device to another device having the capability to establish said communications links with said server for requesting and forward downloaded DAB components to said mobile communications device, and wherein said mobile communications device sends said request and receives said downloaded receiver components using the communications link between said other device and said server.

In one embodiment, said mobile communications device generates said request using a wireless communications link, and wherein said other device receives said downloaded receiver application components over a different communications link.

In one embodiment, said mobile communications device is connected to the other device subsequent to said other device receiving said downloaded receiver components.

In one embodiment, a device identity for the mobile communications device and a device identity for the other device is included in said request to said server.

Another aspect of the invention comprises a method of provisioning a mobile communications device with a receiver application according to any previous claim, wherein said step of installing said one or more receiver application components on to said mobile communications device comprises:
configuring a DAB receiver application including one or more DAB application components to interface with said receiver circuitry, thereby enabling said DAB receiver application to simultaneously decode a plurality of audio and/or video content sub-channels output by said receiver module to enable said device to play a DAB service channel.

In one embodiment, said one or more receiver application components downloaded to said mobile communications device are one or more of the following:
additional receiver application components for use by an existing receiver application installed on said mobile communications device; and/or
receiver application components which replace equivalent one or more receiver application components of an existing receiver application installed on said mobile communications device; or
receiver application components comprising a reconfigurable receiver application for said mobile communications device; or
receiver application components comprising a new version of an existing reconfigurable receiver application for replacing an existing reconfigurable receiver application of said mobile communications device.

In one embodiment, the user of the mobile communications device triggers said step of generating a request for one or more receiver application modules.

In one embodiment, an existing receiver application provided on said mobile communications device is arranged to interface with one or more communications applications capable of generating said request for one or more receiver application modules, and said receiver application is arranged to automatically trigger said step of generating a request for one or more receiver application components if said existing receiver application receives any data having a data format which said receiver application does not recognise.

In one embodiment, said request establishes an Internet supported web-browser session with said remote server over said wireless communications network, and wherein said web-browser session is on-going during said step of downloading said receiver application components.

In one embodiment, said request comprises a request to establish an initial Internet supported web-browser session with said remote server over said wireless communications network, and wherein said initial web-browser session is terminated prior to said step of downloading said receiver application components.

In one embodiment, said DAB application components are subsequently downloaded using either a file-transfer protocol from a remote site or in a new session associated with the same user identity as a user identity associated with the original session

In one embodiment, said remote server receiving said request stores said request in a data store in an appropriate form, and when said remote server receives one or more DAB application components, determines by appropriately performing a lookup operation on said data store, that said mobile communications device has previously requested an update, and said remote server establishes a session with said mobile communications device over said wireless communications network to provide said mobile communications device with said one or more previously requested DAB application components.

Another aspect of the invention seeks to provide a mobile communications device having a digital broadcast receiver application configured to run on the mobile communications device, wherein the receiver application is configured using a method according to any previous claims, and the mobile communications device comprises:
means to generate a request for at least one component of the receiver application using a communications application of said mobile communications device;
means to communicate the request over a bi-directional wireless communications network to a remote server;
means to download said one or more receiver application components to the mobile communications device over said bi-directional wireless communications network; and
means to install said one or more receiver application components onto said mobile communications devices.

Another aspect of the invention seeks to provide a server arranged in use to be accessible over a wireless communications network by a mobile communications device, the server being arranged to provision said mobile communications device with a digital broadcast receiver application capable of being configured to run on the mobile communications device using a method aspect of the invention, the server comprising:
means to receive a request generated by said mobile communications device and communicated using said bi-directional wireless communications network;
means to process the request to identify one or more receiver application components suitable for download to the mobile communications device; and
means to generate a signal comprising data for downloading said one or more receiver application components to the mobile communications device over said bi-directional wireless communications network.

Another aspect of the invention seeks to provide a signal arranged to convey data from a server aspect of the invention to a mobile communications device aspect of the invention over said wireless communications network, said signal comprising data for downloading said one or more receiver application components to the mobile communications device.

Another aspect of the invention seeks to provide a digital receiver module, the module comprising receiver circuitry arranged to be integrated into a mobile communications device and comprising:
means for tuning and receiving a digitally broadcast signal comprising at least one time-division multiplex of sub channels;
means for partially decoding a received multiplex to extract at least sub channel identifiers for a plurality of sub channels of said multiplex;
means to signal said received identifiers for said multiplex sub channels to a receiver application supported by an operating system of said mobile communications device; and
means to send said received sub channels to said receiver application; wherein, said step of partial decoding said received multiplex is implemented by a decoder of said digital receiver module arranged to utilise resources shared with other applications supported by said operating system of said mobile communications device.

In one embodiment, said shared resources comprise one or more of the following:
a shared random access memory resource;
a shared flash memory resource;
a shared dynamic memory resource;
a shared processor resource.

In one embodiment, the receiver module further comprising means to selectively remultiplex a sub-set of the plurality of sub-channels demultiplexed from said digitally broadcast signal by said receiver circuitry, wherein said step of sending said received sub-channels to said receiver application comprises sending said remultiplexed subset of sub-channels, and wherein said receiver application comprises means to demultiplex said received subset of sub-channels.

Another aspect of the invention seeks to provide a mobile communications device comprising a router module for separating out sub channels in a received digitally broadcast time-division multiplex, at least two of said sub channels comprising audio and/or video content and at least one sub-channel comprising programme guide information, said sub channels being provided as input to a plurality of decoding means, wherein the decoding means decode the sub-channels to provide displayable/playable content through means provided on said mobile communications device.

In one embodiment, said decoding means is remotely configurable.

In one embodiment, said decoding means is reconfigurable remotely in an automated manner by an application running on said device.

In one embodiment, said decoding means is reconfigurable in a user controllable manner.

In one embodiment, said decoding means is reconfigurable to change the protocol of the video and/or audio content decoded.

In one embodiment, said TDM multiplex comprises a plurality of sub channels, at least two sub channels relating to the same type of content conforming to differing protocols.

In one embodiment, said displayable content is rendered using the same means provided for rendering the user interface of said mobile communications system.

Another aspect of the invention seeks to provide a DAB application arranged to be provisioned for remote configuring on a mobile communications device aspect of the invention using an appropriate method aspect of the invention.

Another aspect of the invention seeks to provide a method of provisioning a mobile communications device with a digital audio broadcast (DAB) application configured to run on an operating system of the mobile communications device, the method comprising:
generating a request for at least one component of the DAB application, said request indicating an identifier for the requesting device capable of being associated with a user profile for a plurality of devices;
communicating the request over a communications link to a remote server;
receiving the request at the remote server;
processing the request to identify one or more DAB application components suitable for the mobile communications device;
downloading said one or more DAB application components to a device selected in accordance with a predetermined set of rules associated with said user profile; and
installing said one or more DAB application components onto said mobile communications device directly if selected, or if another device is selected downloading said one or more DAB application components to said other device, wherein said installation of said DAB application components occurs when said mobile communications device connects to said other device.

In one embodiment, the downloading server selects one or more DAB application components for download to said device based on information provided by an identifier for said mobile communications device which identifies what, if any, existing DAB application components are already installed on said mobile communications device.

In one embodiment, the request specifies the DAB application components which are to be downloaded.

In one embodiment, prior to said the step of installing said DAB application components, said mobile communications device determines what resources controlled by the operating system of the mobile communications device are required to complete the installation, and if not available, requests the operating system of the mobile communications device to reallocate resources utilised by other applications to enable said installation process to proceed.

In one embodiment, during said the step of installing said DAB application components, said mobile communications device determines what resources controlled by the operating system of the mobile communications device are required to complete the installation, and if not available, requests the operating system of the mobile communications device to reallocate resources utilised by other applications to enable said installation process to proceed.

In one embodiment, if sufficient resources are not made available following said request for more resources, the installation process is terminated.

In one embodiment, the user of the mobile communications device is alerted to one or more characteristics of the resource conflict between the installation process and other applications running on said operating system, and said alert is arranged to prompt the user to selectively terminate one or more other applications or the installation process.

In one embodiment, one DAB application component comprises a component related to a characteristic of an electronic programme guide for bearer content received by said DAB application from a DAB receiver module of said mobile communications device.

Another aspect of the invention seeks to provide a mobile communications device comprising:
pre-installed receiver hardware for the reception of digitally broadcast signals, said receiver hardware being pre-installed in a form unable to play received signals on said communications device; and
means to install one or more components of an application on said mobile communications device, the installed application enabling the play of a selected received signal on said mobile communications device.

In one embodiment, the mobile communications device further comprises:
means to receive one or more additional components of an application, whereby said one or more additional components enable play of a received signal previously not playable on said mobile communications device.

In one embodiment, the installed application activates and control said pre-installed receiver hardware to enable play of a selected signal.

In one embodiment, said one or more components are provided by a remote server and are downloaded to said mobile communications device.

Another aspect of the invention seeks to provide a method of enabling a mobile communications device to play a received signal, the mobile communications device comprising pre-installed receiver hardware for the reception of digitally broadcast signals, said receiver hardware being pre-installed in a form unable to play said received signal on said communications device, the method comprising:
determining that said received signal is not playable on said device;
generating a request for means to play said signal on said device, said means comprising one or more components of an application whose installation on said mobile communications device will enable said received signal to be played on said device;
receiving said one or more components;
installing said one or more components on said mobile communications device, whereby the installed application enables the play of said received said communications device.

In one embodiment, in said step of generating a request, said request is sent to a remote server which processes information provided in said request to determine which one or more components will enable said received signal to be played on said device.

In one embodiment, in said step of generating a request, said request is sent to a remote server containing an indication of which one or more components will enable said received signal to be played on said device.

In one embodiment of the invention, a digital broadcast receiver is provided as a detachable DAB radio and/or video receiver component which can attach to another device. In one embodiment, the detachable DAB receiver component is provided as a detachable (for example, a “fob” type) device which interfaces with another device via an appropriate interface such as a Universal Serial Bus port to share the resources of the other device. The interface enables the digital broadcast receiver component to use the power, memory, and optionally transmission and/or receiver resources of the other device. In one embodiment, the detachable DAB receiver component is self-contained and does not require installation on its host device, which enables it to be portable between a plurality of different host devices. This embodiment is functionally a “plug and play” type component which allows a user to receive DAB signals easily in devices regardless of whether user has “permission” to install software on such other devices. This enables a user to take the detachable DAB receiver component provided with the USB jack interface and simply attach this to any other device able to share the necessary resources such as electrical power and/or memory and/or antenna and/or transmission resources whenever they want to utilise the DAB radio function.

In one embodiment, a jack is provided on the detachable DAB receiver component to enable the user to connect a headset for listening to the received signals. In one embodiment, if the device to which the DAB component is attached has suitable display means, the video signals will be displayed on the display of the attached device. In one embodiment, if the device to which the DAB component is attached has suitable audio output means, the DAB audio is played through the audio output means of the other device. In one embodiment, the headset attached to the detachable DAB component has an antenna functionality for the reception of the DAB signals. Examples of other devices to which the detachable DAB receiver component may be attached include, for example, a mobile communications device and/or laptop and/or desktop computer or any other device with a suitable interface component for receiving the audio and/or video data output by the detachable DAB receiver component.

The DAB receiver component (provided either integrally within a communications device or as an attachable/detachable component) comprises a receiver for digitally broadcast signals which comprises a software application for receiving a multiplex of digital audio broadcast (DAB) sub-channels from receiver hardware (e.g. from circuitry which may require software to function properly). The application and/or the receiver circuitry may be changed by means of additional software being downloaded to the device over an air or wired interface or loaded on to the DAB receiver component by other means.

The DAB receiver application of the invention is arranged to selectively decode one or more sub-channels from a received multiplex signal comprising a plurality of sub-channels using resources shared with the operating system of the mobile communications device. This enables a device to be operated whilst software to reconfigure one or more components of the software radio is received in background either via the broadcast system or via another communications link. In particular, the invention enables an end-user to operate another device to control the reconfiguration of the receiving device (which is operated by the end-user (i.e., the content subscriber)). In this way, the timing of reconfiguration and/or the technology of the reconfiguration can be controlled by a user of the device to suit the constraints of the device and/or the user's personal wishes.

Thus a digital broadcast receiver according to an embodiment of the invention uses a layered DAB module in which reconfigurable coded elements are separated from the underlying code that handles the core functionality to facilitate the extraction of signalling information from received broadcast signals. By separating signalling information from the broadcast signals using reconfigurable software, the invention enables the audio path within the remaining coded elements to support mixing and/or switching of one or more DAB radio sources with other audio sources as well as providing flexibility to add features and/or make any changes to the host communications device (for example, a mobile phone handset). This is achieved by using a DAB chipset only for some initial (core) receiver functions which generate raw channel data. The hardware components then send a plurality of raw channel data streams to receiver software components which share the use of an application processor in the host device with other applications running on the host device. This allows more than one channel to be streamed from the DAB chipset to the host processor and allows extended features to be implemented such as:
background download of EPG data from one stream whilst audio is played from another stream;
recording of one stream whilst another is played;
download of other files and services while a stream is played; and
the addition of new services not envisaged when the chipset was designed.

The invention also enables processing of electronic programme guide information to enable this information to be displayed more rapidly when requested by a user, and to enable the electronic programme guide to be updated in a manner which utilises the resources of a mobile communications device more efficiently.

The invention thus enables electronic programme guide information to be pre-processed by the mobile communications device prior to display. It also enables electronic programme guide information to be updated more rapidly. In particular, one embodiment enables a background update of EPG information relating to other un-decoded channels received by the DAB application in a multiplex from the DAB receiver hardware whilst a user-selected service channel is decoded by the DAB application for display on the mobile communications device.

### LIST OF FIGURES

Embodiments of the invention will now be described with reference to the accompanying drawings which are by way of example only and in which:

FIG. 1 shows a functional block diagram of a mobile communications device having a receiver according to one embodiment of the invention;

FIG. 2 shows a functional block diagram of a mobile communications device having a receiver according to another embodiment of the invention;

FIG. 3 shows in more detail the functional processes of the receiver according to an embodiment of the invention;

FIGS. 4a and 4b are schematic diagrams showing certain steps performed in methods of receiving digitally broadcast sub-channels according to embodiments of the invention;

FIG. 5 is a schematic diagram showing steps in a method of configuring a receiver of a mobile communications platform according to another embodiment of the invention;

FIGS. 6A to 6C are schematic diagrams showing alternative schemes for downloading receiver software components for installation on a mobile communications device according to various embodiments of the invention; and

FIG. 7 shows how electronic programme guide (EPG) information is processed in an embodiment of the invention.

### DETAILED DESCRIPTION

The best mode of the invention currently contemplated by the inventor will now be described with reference to the accompanying drawings. Features which are well known in the art in the context of the invention may be omitted from the description entirely or not described in explicit detail herein. Where omitted from the description, further detail can be obtained from publications well known to those of ordinary skill in the art such as: BS EN 50248:2001: Characteristics of DAB receivers, and ETSI EN 300 401 V1.3.3 (2001-05): Digital Audio Broadcasting (DAB) to mobile, portable, and fixed receivers, the final draft of ETSI EN 301 234 V2.1.1(2005-02): Digital Audio Broadcasting (DAB); Multimedia Object Transfer (MOT) protocol; ETSI ES 201 735 V1.1.1 (2000-09):Digital Audio Broadcasting (DAB); Internet Protocol (IP) datagram tunnelling; IETF RFC 791 (1981): “Internet Protocol (IP); Darpa Internet Program; Protocol Specification” J. Postel, IETF: RFC 2616 (1999-06): Hypertext Transfer Protocol—HTTP/1.1; Draft file ETSI_TS_Enhanced packet mode 21_{—}11_{—}04.doc: Digital Audio Broadcasting (DAB); Enhanced Packet mode; ETSI TS 101 756 V1.1.1 (2000-10): Digital Audio Broadcasting (DAB); Registered Tables; ETSI TS 102 818 V1.2.1(2005-01): Digital Audio Broadcasting (DAB); XML Specification for DAB Electronic Programme Guide (EPG); ETSI TS 102 371 V1.1.1. (2005-01) Digital Audio Broadcasting (DAB) Transportation and Binary Encoding Specification for DAB Electronic Programme Guide; and Digital Audio Broadcasting (DAB); and Multimedia Object Transfer (MOT) protocol ETSI EN 301 234. Also specified in the DAB standards are certain command sets for receivers, for example, British Standard EN 50320:2001 describes a get_receiver_capability which allows a DAB controller to ask the DAB receiver for its capabilities, and a notify_receiver_capabilties command which enables the DAB receiver to provide its capabilities to the controller. British Standard EN 62105:2002 “Digital Audio Broadcasting System—Specification of the Receiver Data Interface” describes the interface between devices such as dedicated decoders for data applications, computers, audio post-processing and recording devices and the DAB receiver. This standard defines a DAB RDI as capable of carrying the full information obtained by the DAB receiver, i.e., the maximum data rate of the MSC, plus the FIC and information on the received transmitters in a suitable format. It also is capable of carrying data in the format of the output format of recently developed channel decoders and input format of audio source and data decoder ICs (the DAB 3 interface). It is independent of any physical interfaces. It is capable of connecting several decoders to a receiver, to implement a return channel for receiver control from an application terminal, and to connect the DAB receiver to a data network. The contents of all of the standards listed herein-above and any other standards known to those of ordinary skill in the art as describing technology which can be used to digitally broadcast audio, video and data signals to mobile communications devices are also hereby incorporated into the description. Where an equivalent element for implementing functionality described herein below is well known in the art, their inclusion in the description is also implicit. Where the following embodiments of the invention refer explicitly to DAB technology, those skilled in the art will appreciate that the invention may be equivalently implemented for other digital broadcast technology, such as DVB, or Motion-Flo etc.

For further background information on DAB technology, the reader is referred to Digital Audio Broadcasting, Principles and Applications of Digital Radio, Edited by Wolfgang Hoe and Thomas Literacy, 2^{nd} Edition, Wiley, 2003, ISBN 0-470-85013-2, the contents of which are hereby incorporated by reference.

A DAB receiver according to the invention is implemented on a communications device, and in the preferred mode of the invention, on a communications device which is mobile. The DAB receiver comprises part of a DAB television component which is either provided as an integral part of the communications device or which is installed on the communications device in a detachable manner. In one embodiment the DAB component is provides as a module which hosted by the communications device in a detachable manner. For example, in one embodiment, the DAB component is provided as a device which interfaces with the host device via a USB port to draw power and share other resources with the host device, such as the video output (display) and audio output (speakers) of the host device. Any device having the necessary resources to output the audio and/or video signals provided by DAB component can function as a host communications device in such embodiments of the invention, including, for example, a mobile communications device such as a telephone handset, a laptop (portable computers), a desktop computer, a handheld personal computer etc. In the preferred embodiment of the invention, however, the DAB component is integrated into a mobile communications handset.

The DAB receiver comprises hardware and software components. The hardware is provided in the form of receiver components and circuitry and in some embodiments of the invention the hardware is reconfigurable using coded components. The receiver hardware is controlled by software components of the receiver and one or more functions are implemented using supplementary one or more software applications, referred to herein as the DAB receiver software (also referred to herein as the receiver application). The DAB receiver software/application is either pre-installed on a device prior to the device being provided to a consumer or alternatively it may be installed on a device by the consumer, providing the device also has the appropriate receiver circuitry and operating system to support the installation process and operation of the receiver application. In some embodiments, described in more detail herein below, the receiver application may be only partially installed prior to use of the device, and one or more additional components of the application are installed after the receiver is already in use.

An electronic programme guide of the invention is generated using a number of programme records which are collated within a data store. The programming elements which process received electronic programme information and interface with the data storage are also components of the receiver application, and as such are capable of being remotely configured/reconfigured in the same manner as other components of the receiver application. The device comprises any device having integrated means for wireless communication with a remote server in the best mode of the invention currently contemplated by the inventors.

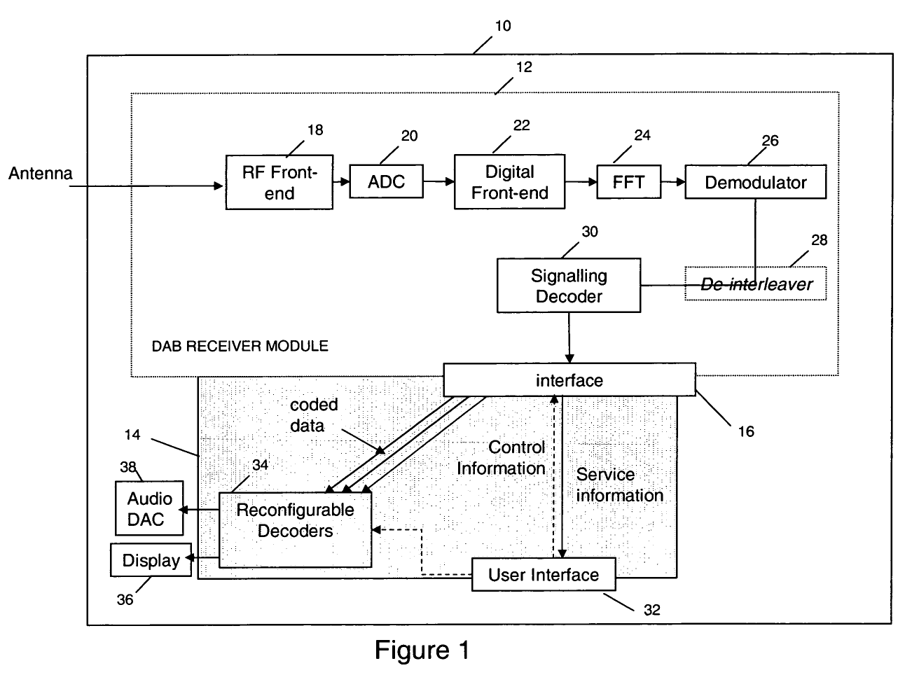

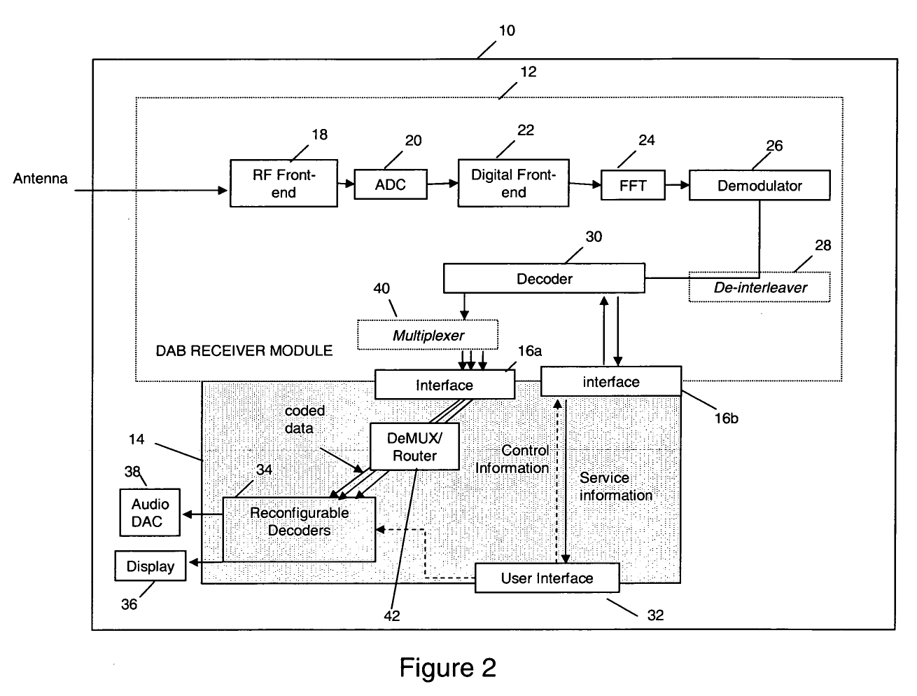

Referring now to FIG. 1 of the accompanying drawings, one embodiment of the invention comprises a communications device having a DAB video receiver. The communications device is a mobile communications device such as a handset and/or a device capable of being integrated into a land or sea, motorised or unmotorised, vehicle or plane. FIGS. 1 and 2 of the accompanying drawings provide schematic functional block diagrams of such a mobile communications device 40 arranged to receive digitally broadcast signals. The mobile nature of the communications device requires a receiver capable of digital broadcast reception over an air interface, i.e., capable of receiving digitally broadcast signals in a wireless communications environment. In addition, the mobile communications device may be provided with wireless communications means for the reception and/or transmission of signals in a wireless broadband environment e.g. such as are supported by the Wireless Fidelity (WiFi), WiMax, Wireless local area network (WLAN) and any other suitable 802.11x and 802.16x standard protocols), short range wireless communications signals such as Bluetooth™, as well as other cellular communications protocols such as GPRS, 3G, UMTS for example.

In FIGS. 1 and 2, the mobile communications device 10 includes digitally broadcast signal receiving means comprising a DAB receiver. The DAB receiver comprises receiver circuitry such as is well known to those of ordinary skill in the art and may be provides as, for example, a reconfigurable DAB receiver hardware module 12 and configuring receiver software. The receiver software includes a receiver application 14 which is supported by the operating system (not shown) of the mobile communications device 10. The receiver circuitry 12 and/or the receiver application 14 are reconfigurable. The receiver application 14 is implemented using reconfigurable means such as software running on the operating system. The receiver circuitry 12 comprises reconfigurable hardware components such as reprogrammable elements of a DAB chipset such as those provided by Radioscape/Texas Instruments software radio components and chipset which are well known to those of ordinary skill in the art.

The receiver application 14 comprises a number of software components and uses shared resources such as the processing, memory resources of the host communications device. These individually or in combination provide functionality which allows a received service channel to be displayed by the mobile communications device 10. Usually the displayed service channel will have been selected by a user of the communications device 10 through an appropriate user interface 32. The receiver application 14 and receiver circuitry 12 are arranged to exchange at least control and signalling information through interface 16 in FIG. 1 and through interface 16b in FIG. 2.

In FIGS. 1 and 2, the receiver comprises circuitry 12 providing means to receive a plurality of received signal multiplexes, e.g., DAB signals, and sufficiently decodes each multiplex to extract at least the FIC information. As shown in FIGS. 1 and 2, where DAB television signals are to be received, the receiver module 12 is a DAB receiver module comprising a RF front end 18, an ADC 20, a digital front end 22, a FFT component 24, a demodulator 26, an optional de-interleaver 28 (shown as a dotted element in FIG. 1), and a decoder 30 for extracting signalling information such as that provided by the Fast Information Channel (FIC) shown in FIG. 1 as a convolutional decoder, for example, a Viterbi decoder.

Also shown in FIG. 1 is an optional de-interleaver 28 which enables a sub-channel from a DAB multiplex to be output directly to the DAB receiver application 14 via interface 16 shown in FIG. 1. In FIG. 1, the receiver circuitry 12 of the module enables one or more sub-channels, e.g. a plurality or as many as all of sub-channels in a DAB multiplex, to be output to the DAB receiver application software components 14 (if so required/desired). However, in practice, this would generate a huge processing load on the receiver application 14. A user interface 32 is provided to allow a user of the mobile communications device 10 to create control information to configure the DAB receiver to receive and process the DAB service selected by the user. A user can additionally provide authentication information via the user interface 32 to enable content-encoded channels to be decoded by a reconfigurable decoder component 34 of the DAB receiver application 14. Once decoded appropriately, the DAB receiver application outputs audio, data and video data to be appropriately played/displayed on the mobile communications device 10 via video output 36 and audio DAC output 38.

FIG. 2 of the accompanying drawings shows an alternative embodiment, in which only a selected number of a plurality of sub-channels from a received multiplex are output to the receiver application 14, here shown as being received via interface 16a. In this embodiment of the invention, the receiver circuitry includes multiplexing means 40 which multiplexes a subset of the sub-channels received in a DAB signal to which the receiver circuitry is tuned, and this sub-set multiplex is output to the DAB receiver application 14, which in turn performs a demultiplexing operation (42) prior to routing the extracted sub-channels to other components (e.g. content decoders 34) of the DAB receiver application 14 for further processing/decoding etc.

Although the interfaces between the receiver circuitry 12 and the receiver application 14 supported by the operating system of the mobile communications device are shown separately in FIG. 2 and as a single component in FIG. 1, those skilled in the art will appreciate that any appropriate number and configuration of interfaces may be provided in practice to enable a user to selectively control the configuration of one or more configurable components of either the receiver circuitry 12 (if provided as reconfigurable hardware) and/or of the reconfigurable software components of the receiver application 14.

The receiver module 12 of FIGS. 1 and 2 comprises components such as receiver circuitry whose functionality is already known and as such the known components and functionality of a DAB receiver module are not described in great detail herein. As mentioned above however, the receiver circuitry may be reconfigurable using software and the software of the receiver may share one or more resources with other components of the mobile communications device 10, in particular, resources which are shared with other applications supported by the operating system of the mobile communications device 10.

For example, in one embodiment of the invention, instead of utilising external memory resources dedicated to the receiver circuitry such as is known in the prior art, the receiver 12 instead shares some of the memory (and in some embodiments the processing) resources with other software applications arranged to run on the operating system of the mobile communications device 10. This is possible because at least the service channels, i.e., the service components, of a received broadcast signal ensemble are not fully decoded by the receiver circuitry 12, but are instead passed to the receiver application 14 as a multiplex requiring further decoding, so that the service components are only fully decoded after being processed using the receiver application 14.

Several coding processes may be applied in a DAB broadcast system such as are shown in FIG. 1 on page 24 of ETSI EN 300 401 (which is incorporated here specifically by reference) for DAB audio programme services, and all necessary decoding processes to display a service channel on the mobile communications device 10 must be performed by the receiver circuitry and one or more appropriate components of the receiver application 14. In the preferred embodiment of the invention, the receiver circuitry 12 of the receiver performs certain decoding processes to extract the signalling information provided by the fast information channel FIC from a received DAB signal. The FIC signalling information is then provided to the DAB receiver application 14 to enable the individual sub-channels in the partially decoded multiplex output by the DAB receiver module 12 to the DAB receiver application 14 to be further decoded by the reconfigurable decoding components 34 of the DAB application 14. Any decoding processes performed by the components of the DAB application 14 are capable of being changed by downloading appropriate components to upgrade DAB receiver application 14.

The above embodiments refer to partially decoded signals being passed to the DAB receiver application 14. Alternatively, in one embodiment of the invention, all decoding processes are provided by the DAB application 14, i.e., they are implemented using software which shares resources and the operating system with other applications hosted by the mobile communications device 10. This embodiment is processor intensive and can negatively impact the power resources of the mobile communications device 10 to the extent other applications are unable to run properly. To prevent this, this embodiment and other embodiments of the invention provides means for a user of the mobile communications device 10 to control the level of sharing, i.e. how usage of the shared resources is partitioned between the receiver and other applications hosted on the mobile communications device 10. Regardless of whether the range of allowed sharing is determined by a user or automatically determined by the mobile communications device, the control information generated limits the extent to which the host device processor has to support the decoding process. This means that the decoding process does not impact other applications running on the mobile communications device in a negative way. The DAB receiver application 14 can implement in software other processes which can also be implemented in hardware by the receiver circuitry 12 (for example, the de-interleaving functionality). Preferably, the functionality implemented in software is configured so that the amount of control information which needs to be exchanged through interface 16 (16a,b) is reduced.

In the preferred embodiment shown in FIG. 1, however, the video and/or audio decoding processes and any decryption codes required to access encoded content are implemented by the DAB receiver application 12. This requires the DAB receiver circuitry 12 to signal information extracted from the FIC of a received DAB signal via interface 16 to the DAB receiver application 14. This information then enables the DAB application 13 to identify the sub-channels carrying the various service components for a selected service channel in the MSC of the received DAB signal provided from the DAB receiver module 12 in order for the mobile communications device 10 to generate audio and/or video output for the relevant service channel for consumption by a user.

The DAB application 14 is also arranged to receive information about what multiplex should be selected through user interface 32 which is arranged to enable a user of the mobile communications device 10 to select a service. The user interface 32 then communicates this control information to the DAB receiver circuitry 12 to enable the DAB receiver circuitry 12 to output the selected multiplex to DAB application 14.

The control information received by the DAB receiver circuitry 12 from the user interface 32 is used to determine which service components should have their sub-channels extracted by the DAB receiver hardware 12 (which may for example be provided as a DAB receiver chipset or electronic circuit module) as is known in the art and output in a form capable of immediate playback through a loudspeaker/display. In addition, DAB receiver hardware 12 separates the FIC from the MSC of a received DAB signal and provides a multiplex of sub-channels to the DAB software application 14 together with appropriate signalling information (extracted from the FIC) for use by the DAB application 14 to selectively extract one or more sub-channels from the entire received DAB multiplex. In this way, a plurality of sub-channels can be selectively received either automatically or in response to user generated control information. For example, a received DAB signal may provide a service component containing sub-channels for audio and/or video and/or data to be played/displayed on the screen/loudspeaker components of the mobile communications device (or stored thereon). In addition, other channels may provide background data downloads, for example, data which enables one or more components of the DAB radio application to be reconfigured or even which allow certain hardware components to be reconfigured.

In one embodiment, this enables the amount of control information which is provided by the DAB application 14 to the DAB receiver module 12 via interface 16 (16a,16b) (which is generated in response to user selection input for a particular service channel received via user interface 32) to be reduced to control information which enables the selection of a frequency the DAB module needs to tune to receive a particular multiplex carrying the selected service channel.

In the embodiment of the invention shown in FIG. 1, the MSC of each multiplex is provided to the DAB application 14 via interface 16 together with a plurality of sub-channels for processing by the DAB application 14 with the FIC information. In alternative embodiments of the invention (see FIG. 2) different interfaces (16a,16b) may be provided for signalling and control information and the multiplex sub-channels.

As mentioned above, DAB multiplexes are provided at differing frequencies. A multiplex may provide one or more service channels which provide consumable content such as audio and/or video and/or data content. A service channel (e.g., BBC1) comprises one or more service components (e.g., an audio component and/or a video component and/or a data component). Each service component is conveyed using one or more sub-channels in the same multiplex. Each sub-channel conveying audio and/or video content is referred to herein as a bearer sub-channel and a multiplex will comprise one or more bearer sub-channels and zero or more data sub-channels (for example, an electronic programme guide sub-channel).

Thus a bearer sub-channel contains source encoded audio and/or video entertainment content components. The term “entertainment content” is used herein to distinguish programme guide content which provides a description of certain characteristics of the “entertainment content”. A television programme or radio show is an example of “entertainment content”, and the electronic programme guide data provides descriptive information about the entertainment content such as its start and end time, and optionally further information about the nature of the content. The electronic programme guide aspects of the invention are described in more detail herein below.

In alternative embodiments of the invention (not shown in FIG. 1) DAB application 14 is arranged to receive one or more DAB multiplexes from the DAB receiver module 12 comprising DAB receiver hardware. This requires either a DAB receiver module which is capable of being tuned to two or more frequencies for multiplex signal reception or a plurality of modules to be provided.

In an embodiment where the entertainment content of the sub-channels on a received multiplex is still source encoded, the DAB application 14 performs additional decoding processes on one or more of the received sub-channels. The additional decoding processes are performed by reconfigurable decoder(s) 34 of the DAB application. A reconfigurable decoder 34 of the DAB application is capable of being modified by downloading different configuration information. In a preferred embodiment, this is performed using a bi-directional mobile communications link from a remote server, such as a cellular communications link or alternatively a broadband wireless communications link such as WiMax, WiFi, WLAN etc.

It is also possible to reconfigure the H/W of the receiver by requesting updates which reconfigure the hardware to allow the reception of signals having different physical characteristics such as frequency (or frequency range), modulation, polarisation etc. Where two tuneable receiver components are provided, one may provide a sub-channel for play/display on the host device whilst the other provides a sub-channel which contains data which can be used during downtime to reconfigure the hardware.

This enables the DAB application 14 to change the type of decoding operation it performs on signals received from the DAB hardware module 12. This is useful in a mobile communications environment where a user may not want to return their mobile communications device for updating to receive signals comprising additional features and/or characteristics (e.g., signals conveying service channels which are encoded differently, or which comprise frames or files having a new type of format, or where the video components for display have a new different definition from that which the mobile communications device was originally intending to display). It is also possible to configure one or more software components of a DAB application 14 according to the invention to utilise the memory and processing resources of the mobile communications device 10 which are shared with other applications running on the operating system of the mobile communications device and to use these resources to decode the television and/or audio services.

As mentioned above, FIG. 2 shows an alternative embodiment, in which control information received via interface 16b from the user interface 32 enables selection of a received DAB service. This control information determines which of the plurality of the sub channels already demultiplexed/deinterleaved from the received DAB signal are to be multiplexed for communication across interface 16a. The DAB application 14 will then need to demultiplex the received multiplex of sub-channels, and process them to determine their type in order to arrange for the channels to be appropriately routed to other components of the DAB receiver application, e.g., to DAB bearer channel decoding components and DAB EPG decoding components. In some embodiments, a plurality of decoding operations is performed on each sub-channel received by the DAB application.

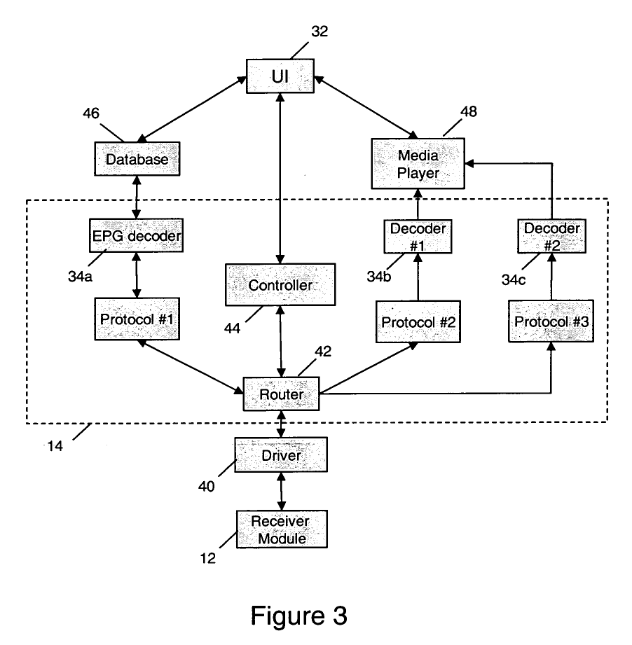

FIG. 3 comprises a schematic diagram showing some functional components of an embodiment of a receiver application 14 according to the invention. FIG. 3 will now be described with reference to DAB technology, although those skilled in the art will find apparent that the functionality described herein in the context of DAB standard technology may be implemented using other digital broadcast technology. In FIG. 3, the receiver application 14 comprises software, e.g., a DAB receiver application, which is supported by the operating system of the host mobile communications device and which shares the use of some of the resources provided on the host device. The software comprises means to exchange control and receiving signalling information from the receiver circuitry (here a hardwired DAB receiver module 12) and a suitable driver 40 for receiving a plurality of sub-channels from the receiver module (for example, a Serial Peripheral Interface driver). The DAB receiver application comprises a number of components, including a router component 42, which is controlled via a controller component 44 (which interfaces with a user interface of the mobile communications device). Unless the sub-channels are received in a de-multiplexed form, prior to the routing operation, a demultiplexing operation will be performed. Router 42 selectively routes received sub-channels according to their type and protocol to one or more decoder components 34a,b,c. Decoder 34a is arranged to decode electronic programme guide data conveyed by a sub-channel conforming to a first protocol #1. Each EPG file is then processed in the manner described in more detail herein below to generate individual programme records which are stored in data store 46. Decoders #1 and #2 34b,c are arranged to decode bearer sub-channels conforming to protocols #2 and #3, for reproduction of the various service components on video/audio output means of the mobile communications device via media player 48 and/or user interface 32.

The sub-channels received via the channel(s) the driver 40 provides comprise one or more bearer sub-channels for audio and/or video entertainment channels and one or more data bearing sub-channels conveying electronic programme guide information for the received plurality of sub-channels. The sub-channels received by a router component 42 of the DAB application will all have the same multiplex frequency (unless the DAB receiver module 32 is arranged to simultaneously receive a plurality of DAB channel multiplexes at different frequencies and provide these to the DAB application). Router component 32 may be provided in a pre-configured or a configurable/reconfigurable form (and by analogy partly implemented in hardware and/or in software).

The DAB application 14 shares one or more memory resources provided on the mobile communications device through a number of appropriately configured interfaces which are not shown in FIGS. 1 and 2 or 3 but which are also supported by the operating system of the mobile communications device. The memory is shared with other applications running on the operating system and comprises any appropriate form, i.e., both static and/or dynamic memory may be shared between the DAB application 14 and one or more other applications.

The DAB receiver module 12 outputs bearer and data channels which are partially decoded to the extent that the DAB receiver application 14 is capable of identifying which one or more of a plurality of bearer and/or data channels received from the DAB receiver module 12 should be further decoded by the DAB application 14 using signalling information received from the DAB receiver module 12 and in accordance with control information provided by user through the user interface (UI) 32. In one embodiment of the invention, the bearer and data channels remain in a multiplex form, i.e., time-division multiplexed, when output by the DAB receiver circuitry 12 to the DAB application components.

When router 42 receives the plurality of bearer sub-channels and a data sub-channel comprising electronic programme guide information for the received multiplex from the DAB receiver module 12, the router 42 is configured to distribute one or more received sub-channels to an appropriate reconfigurable decoder component(s). In FIG. 3, a plurality of reconfigurable decoder components 34a,b, and c are shown (shown as decoder 34 in FIGS. 1 and 2).

In the exemplary embodiment shown in FIG. 3, three sub-channels are extracted from a received multiplex for decoding by the DAB application 14. Router 42 separates the sub-channels for processing by additional components of the DAB application 14. As shown in the exemplary embodiment of FIG. 3, each sub-channel conveys a signal. These represent different service components, for example, one sub-channel conveys EPG information, and the other two may convey components of one or two different entertainment channels.

In FIG. 3, a received sub-channel conforming to protocol #1 is decoded by an electronic programme guide (EPG) decoding component 34a, and processed as described in more detail herein below. The decoded, processed EPG information is then stored in a database 46. Bearer Sub-channels conforming to differing protocols #2 and #3 are routed to respective reconfigurable decoders 34b and 34c. The reconfigurable decoders 34b,c are arranged to only decode source encoded sub-channels which the user of the mobile communications device has subscribed to, and router component and/or the decoder component and/or media player component may control the decoding operation to ensure that only content for which the user has subscribed to is decoded. Although two simultaneous decoders 34a,b are shown in FIG. 3, which enables one sub-channel to be recorded and stored (not shown in FIG. 3), one decoder is sufficient if recording and simultaneous viewing of an alternative sub-channel is not required. Alternatively, one decoder may be used to decode an audio sub-channel and another a video sub-channel for service components which are part of the same or differing service channels of the same ensemble. In one embodiment, companion data services are provided using one or more sub channels.

It is also possible to provide more than two reconfigurable decoders, which would enable two sub-channels to be stored whilst a user views a third sub-channel. This requires more shared memory resources (used by the decoders), increases the amount of processing power the decoding component utilises and may require more resources for the stored programme(s).

A decoded sub-channel is provided in a form which enables appropriate reproduction by a media player application (48) also supported by the operating system of the mobile communications application, such as Windows Media Player™. The operation of the DAB application in terms of which sub-channel (or more than one sub-channels if recording features are implemented as described above) is selectively decoded from a multiplex of sub-channels received from the DAB module is controlled by the user through a suitable user interface 32 which is provided with programme information from the database 76 of electronic programme guide content. The selection may be implemented by the DAB Controller 44 which is controlled by the user interface component 32 in one embodiment of the invention to enable selection of one or more specific sub-channels for delivery of a service channel to audio and/or video output means of the mobile communications device.

To enable the DAB Controller to selectively control which sub-channels are required for decoding a particular service channel, the router component 42 of the DAB component is also reconfigurable. Each sub-channel in the TDM multiplexed content stream which passes through the interface between the DAB receiver module 12 and DAB application 14 running on the operating system of the mobile communications platform is capable of being identified in the multiplexed stream using signalling information (e.g. the FIC) which accompanies the MSC information in the DAB multiplex signal. The processor implementing the routing function provided on the mobile communications platform uses the signalling information generated by partially decoding the received DAB multiplex to determine what sub-channels require decoding. The information to identify individual sub-channels in the received data stream can be provided by the DAB receiver module 12 over the interface 16 (16a,16b) with the DAB application 14.

The DAB receiver hardware 12 outputs a DAB ensemble comprising multiple service channels sharing one or more DAB bearer sub-channels in which each service channel is separately identified by having its own DAB service ID. The DAB service ID information enables each sub-channel to be mapped by the DAB application 14 to appropriate user-friendly sub-channel identifier for display in an electronic programme guide.

In a preferred embodiment of the invention, when tuned to a service on a multiplex or at other times, the DAB application 14 will automatically identify all EPG services on the applicable multiplex and will download and decode them. EPG services are appropriately signalled to the DAB application 14 by the DAB receiver hardware module 12. The service channel identifier can be signalled using MSC packet data and each EPG service is provided with a single primary service component. The data group packet address for each sub-channel for a service can be signalled by the FIG and corresponding service channel identifier. In some embodiments, multiple data streams are carried within the same sub-channel. This requires each data stream to use different packet addresses, increases the receiver power consumption and can also decrease the Reed-Solomon forward-error correction.

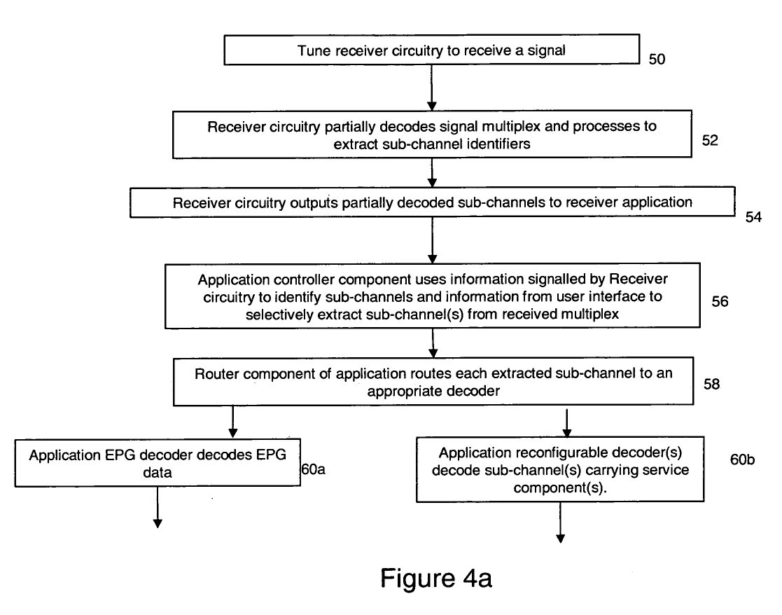

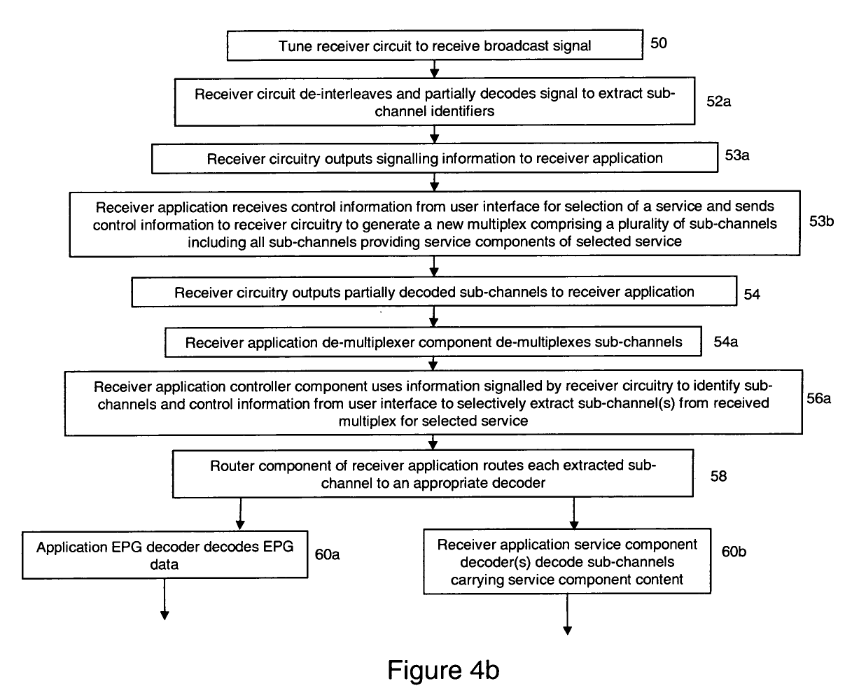

FIGS. 4a and 4b show schematically certain steps performed in methods of receiving and playing digitally broadcast service channels according to the invention.

FIG. 4 shows an embodiment of the invention, in which a receiver module 12 is tuned to receive a digitally broadcast multiplex signal using control information provided by user interface 32 (step 50). The receiver module 12 extracts sufficient information by decoding the received signal to enable sub-channel identifiers to be determined (step 52). The controller component of the receiver application receives the signalling information (step 54) extracted by the receiver module 12 and uses this to identify which sub-channels carry service components of service channels (step 56). The user selects a service channel to view using the user interface 32, and this information is processed by the controller component to configure the router 42 to select the appropriate sub-channels carrying service components for the selected service channel to be directed to suitable encoding elements of the receiver application 14 (step 58). The controller also controls the background processing of sub-channels carrying electronic programme data, or other data, for example, data enabling the receiver application to be reconfigured. The provision of at least two de-coding components by the receiver application enables simultaneous decoding of EPG data by a first decoder (step 60a), whilst a second decoder(s) decode signals conveyed on bearer channels to allow a user to consume the service channel as requested.

FIG. 4b shows the steps which are required for the mobile communications device of the type shown schematically in FIG. 2 to receive and display a digitally broadcast audio/video signal such as a DAB signal.

In this embodiment of the invention, the receiver circuit is tuned to receive the broadcast signal (step 50). The receiver circuit de-interleaves and partially decodes the signal to extract sub-channel identifiers (step 52a), and provides signalling information to the receiver application via interface 16b (step 53a).

The receiver application receives user input from the user interface 32 to select a particular service channel for display. In other embodiments, users can input one or more channels to record in addition to/instead of displaying a service channel. This input is processed and control information is sent to the receiver circuitry to tune the receiver and/or select a particular set of sub-channels including the sub-channels carrying the service components for displaying the user selected service channel which the receiver circuitry multiplexes (step 53b). In one embodiment of the invention, the set of sub-channels selected includes the sub-channels for the user-selected service channel components and sub-channels carrying electronic programme guide for all service channels of the broadcast signal received by the receiver circuitry.

In one embodiment, the sub-channels are partially decoded prior to being re-multiplexed by the receiver circuitry for output to the receiver application (for example, DAB sub-channels are partially decoded following one or more decoding operations performed by the receiver circuitry to remove transmission encoding). The partially decoded multiplexed channels are sent via an interface (e.g., interface 16b in the embodiment shown in FIG. 2) to the receiver application (step 54). A component of the receiver application then de-multiplexes the received sub-channels (step 54a).

A controller component 44 of the receiver application then uses the signalling information provided via interface 16b from the receiver circuitry to identify individual sub-channels and control information from the user interface to selectively extract relevant identified sub-channel(s) for the user selected service channel and also any other sub-channels which the receiver application is configured to process, such as sub-channels carrying data for a data service component such as electronic programme guide information (step 56a).

A router component of the receiver application (which also performs the above demultiplexing/extraction processes in one embodiment of the invention), then routes each extracted sub-channel to an appropriate component of the DAB application for further processing, for example, in FIG. 4b, the router component routes each extracted sub-channel to an appropriate decoder (step 58). In FIG. 4b, an EPG decoder component of the receiver application decodes EPG data in the manner described in more detail herein below (step 60a) and one or more decoder components of the receiver application will decoded one or more sub-channels for selected service channel(s).

In one embodiment, on start up of the mobile communications device and during execution of the receiver application programme, the receiver application will check if sufficient memory is available for it to execute. In another embodiment, it will also check for sufficient resources such as memory, processing power, battery power, when generating, updating and displaying electronic programme guide information and during related processing steps. If sufficient resources are not available, of if they approach a predetermined cut-off value, the receiver application automatically requests the operating system of the mobile communications device to provide more memory by closing down other applications. In one embodiment of the invention, a predetermined hierarchy for the closure of applications is established based on a predetermined set of rules, which may be generated by the receiver application, the operating system, and/or the user. If the closure of other applications does not provide enough memory to enable the receiver application to continue, the receiver application is configured to automatically close down prior to running out of memory. In one embodiment of the invention, instead of the application (or operating system of the device) automatically closing down other processes and/or application, a user of the device is able to selectively control which applications and the order of applications to shut down in preference to maintaining the receiver application operational or delay installation/operation of one or more components of the receiver application.

In the above description of the invention, features which have been explicitly recited with reference to one embodiment may be included in other embodiments of the invention in any appropriate manner apparent to one of ordinary skill in the art.

The invention thus provides a receiver for digitally broadcast signals comprising components configured in hardware (receiver circuitry) and components implemented using software which runs on the operating system of the mobile communications device. Features described herein which are not explicitly indicated as being provisioned in one form may be provided in an alternative form.

The following embodiment describes the process where a DAB television receiver application is implemented for the display of DAB service channels on the mobile communications device. Those of ordinary skill in the art, however, will be aware that equivalent features and functionality can obviously be implemented for alternative digital television and/or radio broadcasting technologies.

DAB software application 14 contains a user interface 32 and other means to interface with the operating system of mobile communications device 10. The user interface 32 enables a user to selectively control what DAB channel is played/displayed, to access EPG information and also request the DAB application to be verified and/or upgraded remotely. It is also possible for a user to request activation of certain features of the DAB application which might be provided but not activated when the device originally ships to the user.

In this way, a mobile communications device according to one embodiment of the invention is provided with a DAB receiver which is reconfigurable by a remote server. The DAB application 14 may be pre-installed when purchased by the user, partially installed, or fully installed, but in each case, the DAB application 14 can receive additional and/or replacement components subsequent to the mobile communications device being purchased by a user by utilising the mobile communications functionality to download additional software.

In one embodiment, a DAB service provider is able to remotely configure/reconfigure certain features of the DAB application using an appropriate interface with the mobile communications device, for example, to push software upgrades to enhance the DAB receiver functionality as a downloaded file which will self-install within the operating system of the mobile communications devices.

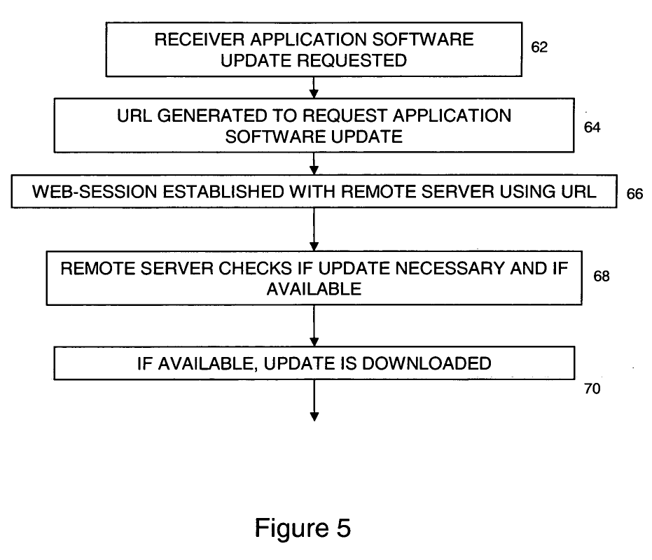

FIG. 5 of the accompanying drawings shows an overview of one embodiment of a reconfiguration process according to the invention. In FIG. 5, a DAB application software update is requested, either automatically or by a user of the mobile communications device (step 62). This causes a Universal Resource Locator to be generated (step 64) which contains a number of fields which identity key features enabling a remote server receiving the URL to identify whether an update is appropriate (described in more detail herein below). A web-session is established with the remote server using the URL (step 66), and the remote server processes one or more fields of the URL to determine if an update is required (step 68). If an update is available, the remote server provides a suitable update by providing a file for download to the mobile communications device (step 70).

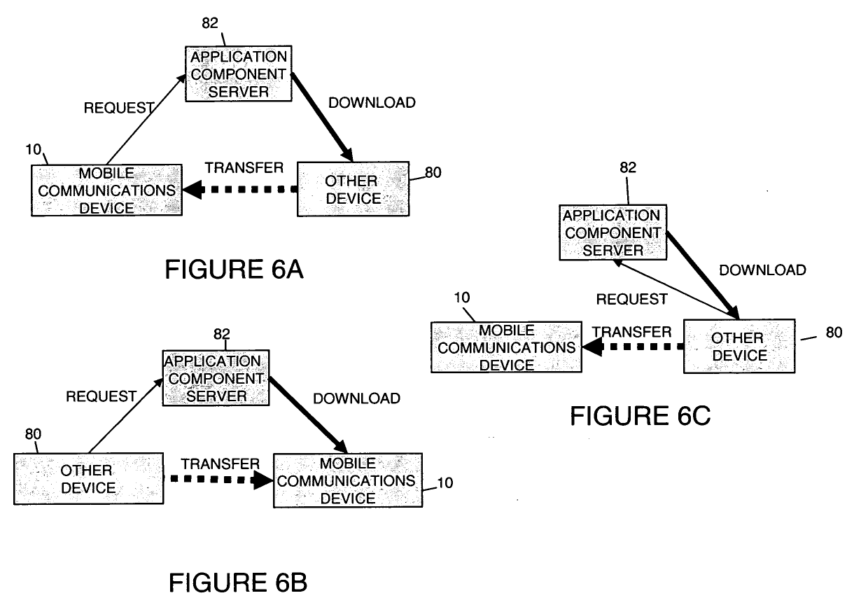

In one embodiment of the invention, one or more receiver application components are obtained by generating a request which is sent to a remote server 80. The remote server 80 is configured to process the received request to provide one or more receiver application components or a complete receiver application for installation on the mobile communications device. The request and download processes utilise the mobile communications device in some embodiments, but in other embodiments of the invention, a proxy device may be used to generate the request and/or receive the download (see FIGS. 6a,b,c, described in more detail herein below).

An embodiment of the invention will now be described in which a user requests an upgrade via the user interface 32 of the mobile communications device (although in alternative embodiments this may be generated using an appropriate application provided by another device capable of conveying the request to the remote server). The input from the user interface 32 generates a request which is sent to a remote server. The request may indicate which component(s) are required, or this may be determined by the remote server using version information for the current application and/or device characteristics and/or the subscriber identity. In a preferred embodiment, the request is communicated over a bi-directional wireless communications network to the remote server and establishes a web-browsing session between the mobile communications device and the remote server.

The request is transmitted using one or more appropriate wireless communications protocols, e.g., WiMax, Wi-Fi, 801.11x, GPRS or 3G over an appropriate wireless network infrastructure. More details of the way a request is generated are provided below. Once the request is received by the relevant server (i.e., the server which is configured to respond to such requests), it is processed to identify one or more DAB application components suitable for download to the mobile communications device, and these are then provided to the mobile communications network in a form suitable for downloading over said bi-directional wireless communications network, or over another link. In this way, a user may generate a request over a narrow-band wired or wireless communications link which is processed remotely but the resulting data components may be only downloaded to the mobile communications device if a broad-band (wired or wireless) connection is available to the mobile communications device.

In a preferred embodiment, the mobile communications device operating system is arranged to automatically install the received said one or more DAB application components onto said mobile communications devices. Alternatively, a user may be prompted to initiate/authorised the download. The download and/or installation may be run as background processes by the operating system of the host mobile communications device.

If downloaded and/or installed as a background process by the operating system of the mobile communications device, a DAB application comprising a number of such components can be provided to the mobile communications device and an existing DAB application already provided on the mobile communications device can be upgraded by providing relevant replacement and/or additional components without disrupting the user's usage of the mobile communications device. Alternatively, installation and/or upgrading of software on the mobile communications device can be performed using any appropriate combination of two uni- or bi-directional communications links, which do not need to involve the same network (for example, a DAB broadcast download can be provided in response to an upgrade request sent over the GPRS link from a mobile communications device). This enables upgrades to be broadcast to all devices (e.g. compulsory upgrades) as well as enabling uni-cast upgrades to specific mobile communications devices. This is particularly useful for enabling software patches to be provided and faults (bugs) to be rectified without asking users to return their mobile communications devices (which unlike set-top boxes may be indispensable) to a service centre. It is also possible for the mobile communications device to use a proxy device to obtain downloads, which is described later herein below with references to FIGS. 6a,b,c of the accompanying drawings.

In one embodiment of the invention, the user is presented with a selectable option from the menu of the user interface to check for software updates. This may be performed using a dedicated key, button or other user-activated means such as a menu or an icon on a graphical user interface.

This generates a request which is communicated to a remote server using a mobile communications protocol, e.g., over a cellular network which supports digital data being transmitted bi-directionally between a mobile communications device and a remote server, for example, WiMax, WiFi, Bluetooth, GPRS, 3G wireless data networks.

In one embodiment, the request may be generated as part of an Internet browsing session with the remote server, or it may be sent in the background (e.g., whilst other applications run in the foreground on the mobile communications device). The URL for the request is generated as a HTTP GET request in accordance with IETF RFC 2616 (1999-2006):Hypertext Transfer Protocol-HTTP/1.1 (a copy of which is available from the Internet Engineering Task Force (IETF) web-site well-known to those skilled in the art), with the following format: http://<baseurl>?<search> where <search> consists of one or more fields of the form <attribute>=<value>, separated by the ampersand character (&) (see below for an example).

The <baseurl> will correspond to a value which is pre-provisioned on the mobile communications device. In one embodiment the value of the <baseurl> is hardwired or hard-coded into the TV and Radio application for security, alternatively, it could be stored by software and suitably encrypted. If hardwired or hard-coded, it is only modifiable by an upgrade of the application configured on the mobile communications device. Alternatively, if suitable security provisions are available, it may be provided in a reconfigurable form (i.e., stored by software), in which case it is possible to dynamically change the baseurl.

When establishing a web browser session, the following field attributes are provided by the mobile communications device: query version, action, DAB date and time, device phone number, device hardware ID, device screen size, device version, UserServiceProvider ID, Service ID. For example:

http://www.xyz.com/open.aspx?QVER=value#1&ACT=value#1&DDAT=
date_time&DID01=abcdefg&DID02=abcdefg&DSS=abcdefg&DVER=
abcdefg-DABplayer-1.2.3&USID=abcd&SID=abcdefg

The attribute names and values shown above are exemplary only. QVER is the attribute name for query version which specifies the version of the query that follows. ACT is the attribute name for the action which specifies the type of query. DDAT is the attribute name for the DAB date and time when the request was generated on the device or when the session with the server was first opened. DID01 is the attribute name for the device phone number; this may be modified by the user. DID02 is the attribute name for the device hardware ID which is a pseudo-unique 64-bit identifier derived from the device Id in a way that is not reversible but is unlikely to result in duplicates, which users are not able to modify. DSS is the attribute name for the device screen size to allow the server to render content appropriately. DVER is the attribute name for the device version, which is assigned by the device manufacturer (or any other party) to assign a name to different versions of the same device. USID is the attribute name for the user service provider identity; this may be configured by the mobile communications device manufacturer, for example via WAP. SID is the attribute name for the service identifier and specifies the service the user is currently consuming.

The ACT field may take a number of values, including an ACT_SOFTWARE_UPDATE value. The server receiving the update request will then inspect the DVER field to determine an appropriate response. If the DVER is not recognised it will provide a response indicating that the DVER is unknown, for example in the form of a text file “unknown.txt”. If the DVER is recognised as being the most up to date version for the hardware, the server responds with an appropriate text file, and if the DVER is recognised as not being the most recent version available for the mobile communications device hardware, a signed software update compressed installation file in a suitable format for the operating system of the mobile communications device (for example, a MicrosoftCAB™ file) will be provided in response which will update the current software to the latest version.

Two types of installation file may be used, depending on whether the installation file contains a compressed copy of all the application files (i.e., all the components of a DAB application are downloaded and a full install is performed) or if the installation file contains only a “patch” comprising one or more components. Where a “patch” is to be installed, the installation file also provides a “patcher” programme to read the existing application files and apply the “patch” to create the new, upgraded version (or to repair any existing application files which have become corrupted or otherwise developed a fault). A “patch” is limited to those components whose installation will implement the necessary upgrade or repair which reduces the size of file needed to download to obtain a new version of an existing DAB application. Whilst the term component has been used herein to refer to specific DAB application functionality, in one embodiment, a patch is limited to comprising sub-components of the DAB application, i.e., only part of each application component. In this way, for a specific component, a patch can comprise either the entire replacement component or only differing sub-components between the new component and the current component installed on the device.

Prior to installing a software update, the application automatically updates the web url favorites list of the user to provide a backup route for the user to get a full software update. The URL saved as a backup route is the same as that originally issued to get the update, except that the DVER field is set to a fail safe value. Where changes are small, the update may be a small patch to bring the software up to date, or where changes are more significant, the update will be a complete new version.

FIGS. 6a, 6b, and 6c show alternative embodiments of the invention in which the mobile communications device 10 is provided with suitable data interface means to connect with another device 80 (e.g., a personal or laptop computer), and the other device 80 is used as a proxy to request and/or download one or more DAB application components from a DAB server 82. If the mobile communications device 10 is connected to the other device 80 at the time the DAB application components are downloaded, the other device 82 functions as a proxy server which relays the DAB application components it receives directly on to the mobile communications device 10. Alternatively, the other device 80 may store the received DAB application components until a user connects it to the mobile communications device 10 in a suitable store. In this embodiment, either the other device 80 drives any subsequent transfer process of the downloaded content when the mobile communications device connects to it or the mobile communications device 10 drives the transfer process. In either case, an identifier of the mobile communications device will be checked as being the same identifier associated with the final destination for the DAB application components the other device 80 has received from the server 82.

FIG. 6A shows an embodiment in which a mobile communications device 10 generates a request to the DAB application server 82 in the manner described hereinabove, but with additional information as a download to the other device 80 is now also requested. This is done in any appropriate way known to those of ordinary skill in the art. For example, in one embodiment, an identifier which the DAB application can resolve to a network address for the other device 80 is provided as a destination address for the downloaded data and included as part of the web-browser session initiation information (for example, it can simply be appended to the url for the download server). In FIG. 6A, mobile communications device 10 generates the request, the server 82 receives and processes the request and pushes the download information to the other device 80. The other device 80 then pushes the downloaded files across an appropriate interface to the mobile communications device 10.

FIGS. 6B and 6C show embodiments where another device 80 requests a download of DAB application components (which maybe to the other device initially as is shown in FIG. 6C or directly to the mobile communications device as shown in FIG. 6B). The other device in these embodiments will establish a session to the download server in a similar manner to that described above where the mobile communications device establishes the download session with the remote server 82. However, to ensure that the downloaded software is only installed on the mobile communications device 10, the request sent by the other device 10 must include details of one or more identifiers for the mobile communications device 10 (as described above). This information can also be determined by connecting the mobile communications device 10 to the other device 80, for example, and/or running a suitable software application on the other device (which is provided on a suitable carrier medium (for example, such as a CD or DVD) to the user when they first purchase the mobile communications device 10. Alternatively, if a user of the other device 80 were to access the download server 82 by a web-portal and establish a session with the download server 82, a prompt to the user to ask the user to connect their mobile communications device 10 to the download server 82 is provided. These techniques enable the user of another device 82 to include the additional download address information associated with the mobile communications device to ensure that the file downloaded is for installation on the right type of device 10.

In one embodiment of the invention, to provide security and simplify the request and download process, the mobile communications device 10 is connected to the other device via a suitable interface to extract information on the identifier(s) for the mobile communications device 10 and/or other device 80. A mobile communications device 10 is capable of determining from this connection the address of the other device 80, and vice versa. Alternatively, other unique identity information (such as for example, might be retained in a user profile for a SIP-enabled mobile communications device 10 and a SIP-enabled other device 80) to provide to the remote server 82 (more details are provided below). Where a different device identity is provided from the identity of the mobile communications device to which the DAB application components are to be downloaded, in one embodiment, the installation process does not execute for the DAB components until the mobile communications device 10 connects to the other device 80 and the DAB application components are transferred to the environment of the mobile communications device operating system.

Some embodiments of the invention are suitable for implementing in a Session Initiation Protocol (SIP) enabled environment, in which each user has a user-profile indicating all devices associated with the user. The user-profile may have rules associated with certain functions which can be performed on the devices 10, 80 associated with the user, which may be time and location specific. Examples of specific rules include, only provide downloads to device 10 after 6 pm or on Sunday's at 6 am, only provide when the user is in a region associated with a high-speed wireless access link, only download if host device idle, . . . etc.

This additional information enables more flexible download schemes, such as those, for example, shown in FIGS. 6a to 6c. In such embodiments, the device requesting the upgrade provides an identifier to the download server 82 which is associated with the user, whose profile can be checked to determine the identity of the mobile communications device 10 which is to be configured with the downloaded DAB application components. In some embodiments, this removes any necessity to append additional device identifiers to the URL to the download server 82.

The download server 82 receives the request from any device, determines from the device identification information for that device 10, 80 the identity of the user associated with that device. The user identity is used to retrieve the profile for that user from a data store. The download server then determines what other device(s) 10, 80 associated with that user identity is (are) capable of receiving the download, and establishes if the user has set up any rules to determine how information is to be downloaded to the device(s). The download server 82 may then either download to a destination device determined in accordance with any predefined rules established for that user profile (which may or may not be directly to the mobile communications device), or alternatively downloads only to one or more devices associated with the user which have connections available with higher bandwidths. In one embodiment, the DAB multi-casts the download to a plurality of other devices associated with the user profile (regardless of location, for example, a work computer, laptop, home computer etc,) and when the user subsequently connects the mobile communications device 10 to any of these other devices the mobile communications device automatically receives the downloaded DAB application components.

In this way, large reconfiguration files can be downloaded using higher bandwidth connections with the server, to the other device and then transferred to the mobile communications device. This embodiment can use less resources of the mobile communications device for the download process. This embodiment also enables the user of the mobile communications device to manage when the upgrade is installed, which allows the user to control when installation uses up resources such as processing, memory and power, and also avoids downloads occurring when the mobile communications device is otherwise in use by the user (e.g., the user is watching a television programme on the device or using the device as a telephone) which could create conflicts with the installation process.

Where a connection is established between the mobile communications device and the other device which is capable of recharging a battery power resource of the mobile communications device, the mobile communications device is configured with the downloaded DAB application components without power constraints being imposed on the installation process. The diversion of a download to another device associated with the user process could be automatically triggered by the mobile device 10 indicating to the server 82 that it has limited processing and/or power and/or memory resources at that particular time. Alternatively, instead of triggering a diversion of a download to an alternative device, the same information can be used to trigger a delay (for example, for a random or pre-determined amount of time) before the remote server 82 pushes the download to the mobile communications device 10.

The embodiments shown in FIGS. 6A, 6B, and 6C enable a user to upgrade the functionality of the DAB application for their mobile communications device simply by sending a request using either their mobile communications device itself or a computer suitably capable of establishing a web-browser session (or any other file transfer session) with the DAB application server. The request indicates where the downloaded DAB files should be sent by the server, and the user of the mobile communications device can then establish a connection with this device to obtain the DAB application components (which could be a short-range wired connection such as might be implemented by a USB cable connection or a wireless connection such as Bluetooth™).

### Electronic Programme Guide Features

In one embodiment of the invention, electronic programme guide information is provided in the form of files conveyed by one or more sub-channels of a multiplex, for example, files which conform to the Digital Audio Broadcasting Multi-media Object Transfer (MOT) protocol for the distribution of electronic programme information, which is described in more detail in ETSI TS 102 371.

A standard MOT file comprises programme information for the predetermined period of one day for one service channel, i.e., which lists all the programmes per “entertainment” audio/video channel within a 24 hour period. Two types of MOT files are provided. The first type of file provides basic electronic programme guide (EPG) information contains information on one service channel for a predetermined duration (e.g., a day or 24 hours), the second type provides advanced EPG information which provides additional detail for one or more programmes listed in the corresponding basic MOT file. Conventionally, an MOT carousel comprises a number of both types of files which are conventionally indexed by channel and by day. Within each file, data is ordered for that channel by time of day. This pre-defined indexing of the data makes the look-up process very inefficient for certain search criteria. For example, conventionally, to find all programmes from any channel at a certain time of day on a certain day requires a number of files to be opened and searched. This requires processing power, a limited resource on mobile communications devices in most operational modes of use. In particular, more processing power is required where an electronic programme guide comprises information from a plurality of files. For example, if information for one channel and day is split into two separate files a “basic information” file and an “advanced” information file, then to obtain the complete information on a programme, both files are read and the records from each reconciled.

An exemplary basic EPG (ehb) programme information file takes the form:

| | |
|---|---|
| Tag xx Length xxxx | <epg> |

Tag xx Length xxx <tokenTableElement>

| | |
|---|---|
| | 0c=[blah_attribute_value] 4 |
| | 03=[blah_another_attribute_value] |
| | 0e=[blah_another_attribute_value] |
| | ... |
| Tag xx Length xx | <defaultcontentIDElement> attribute_value (e.g. e1.ce15.c22c.0) |
| Tag xx Length xxxx | <schedule> |
| Tag 80 Length 2 | <version> attribute_value (e.g., 4) |
| Tag 24 Length 14 | <scope> |
| Tag 81 Length 5 | <stopTime> attribute_value |
| | (for all programmes listed in the file e.g. 2006-06-13T23:00+1:00) |
| Tag 80 Length 5 | <startTime> attribute_value |
| | (for all programmes listed in the file, e.g. 2006-06-12T23:00+1:00) |

Then for each programme the file contains the following type of information:

| | |
|---|---|
| Tag 1c Length 59 | <programme> |
| Tag 81 Length 3 | <shortId> attribute_value (e.g. an identifier such as 0123456) |
| Tag 11 Length 15 | <mediumName> |
| Tag 01 Length 13 | <CDATA> attribute_value |
| | (e.g., an abbrieviated title such as “Day of the Trif~”) |
| Tag 12 Length 20 | <longName> |
| Tag 01 Length 18 | <CDATA> attribute_value |
| | (e.g., the actual title, such as “The Day of the Triffids”) |
| Tag 19 Length 13 | <location> attribute_value |
| Tag 2c Length 11 | <time> attribute_value |
| Tag 81 Length 2 | <duration> attribute_value (e.g. 00:30:00) |
| Tag 80 Length 5 | <time> attribute_value (e.g. 2006-06-12T23:00+1:00) |

More detailed information on programme content is provided in a second file, exemplary extracts from an advanced (eha) EPG programme information file and the first programme listing (of many) is shown below:

| | |
|---|---|
| Tag 02 Length 11533 | <epg> |
| Tag 05 Length 6 | <defaultcontentIDElement> |
| Tag 21 Length 11521 | <schedule> |
| Tag 82 Length 3 | <originator> |
| Tag 80 Length 2 | <version> 4 |
| Tag 81 Length 6 | <creationTime> |
| Tag 1c Length 806 | <programme> |
| Tag 81 Length 3 | <shortId> |
| Tag 80 Length 32 | <id> |
| Tag 19 Length 13 | <location> |
| Tag 2c Length 11 | <time> |
| Tag 83 Length 2 | <actualDuration> |
| Tag 82 Length 5 | <actualTime> |
| Tag 13 Length 698 | <mediaDescription> |
| Tag 1a Length 154 | <shortDescription> |
| Tag 01 Length 152 | <CDATA> Join Mrs. Blah for more from her amazing show, |

with lots of interesting characters and fun things to watch. [Rptd today 3.00pm]

| | |
|---|---|
| Tag 1b Length 538 | <longDescription> |
| Tag 01 Length 534 | <CDATA> Join Mrs. Blah for today's funny stories. After a |

wander around a strange park listen to the next part of “Domestic Appliance Confessions”. In
the next episode of Some Schoolboy Yarn, Joe Bloggs finds out that his maths teacher is
actually trying to teach him algebra. We travel to the town of Dinosaur Jewel next, in a
particular author's tale about an imaginary member of royalty. And finally, discover some even
more detailed information...

| | |
|---|---|
| Tag 14 Length 5 | <genre> |
| Tag 80 Length 3 | <href> |
| ... | |
| Tag 14 Length 5 | <genre> |
| Tag 80 Length 3 | <href> |
| Tag 18 Length 34 | <link> |
| Tag 80 Length 23 | <url> |
| Tag 83 Length 7 | <description> |

The above textual information is representative of the meta-data formatted files which are downloaded via the DAB multiplex sub-channel(s) which provide the relevant descriptive information, for example as .xml formatted files.

Both the basic and advanced electronic programme guide information are provided in the same data stream, but alternatively, they can be provided in separate data streams. Where this occurs, the receiver application of the invention is able to receive both data streams but to process only basic electronic programme files under certain conditions, for example, if processing, power or data storage resources are limited. Alternatively, a user of the mobile communications device may selectively configure the receiver application using the user interface of the mobile communications device to decode only the basic electronic programme guide information.

As the above extracts show, the structure of an electronic programme file is such that for each day of programming a file must be downloaded for each service channel (i.e., for each entertainment channel provided on a multiplex). It is advantageous commercially to use the “EPG” to advertise additional content from channels for which the user does not currently subscribe to as a means of promoting user interest in those channels. As a result, it is very tedious to a user to have to wait for an entire EPG to be populated with content by downloading and reading each EPG file as it is updated.

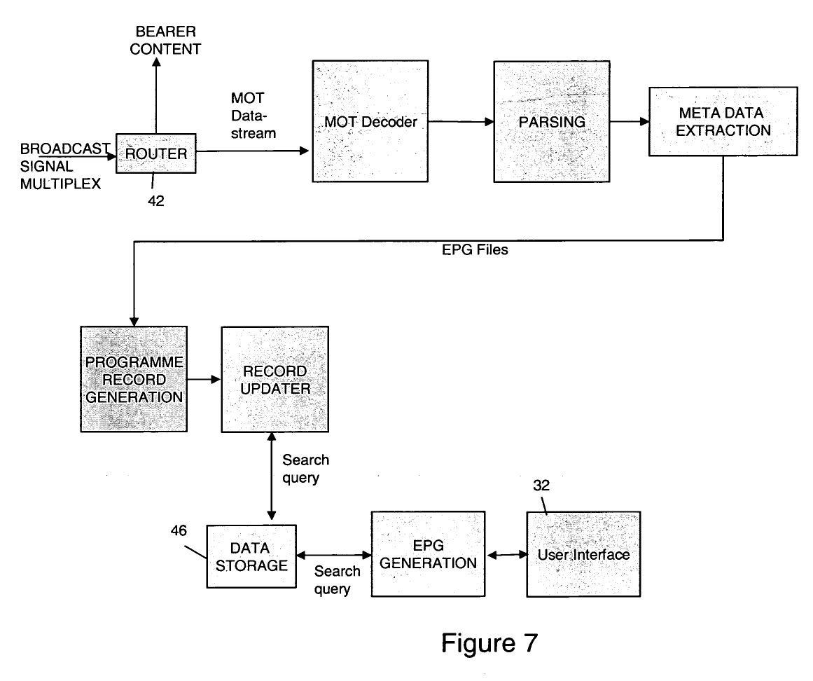

In one embodiment of the invention, with a view to decreasing the delay experienced by a user who has requested to view electronic programme guide information prior to the display of the electronic programme guide, as each file is streamed to the DAB application by the DAB receiver circuit, it is opened and processed. FIG. 7 of the accompanying drawings shows an overview of this process.

In FIG. 7, router 42 has separated out the relevant sub-channel(s) containing electronic programme information. This may require additional decoding steps (not shown in FIG. 7) in some embodiments of the invention) prior to the electronic programme file being parsed to extract certain relevant metadata and to enable, for each information component relating to an individual programme, a programme record to be created and stored.

In one embodiment, once a record has been generated, an update process is performed. This verifies if a record previously exists for that programme in data storage component 46. This process is described in more detail herein below. The data records in the data storage component 46 are indexed to facilitate their retrieval for the generation of programme guide information, which is then displayed. The display programme guide information is interactive so that when a user selects a particular display icon, an action takes place, for example, the relevant programme is displayed and/or recorded and/or additional electronic programme guide information is displayed. Alternatively, the user interface may be configured to enable the user to selectively extract information from the data store 46 to generate a personalised electronic programme guide or to generate an electronic programme guide based on one or more user-selected search criteria.

Each program record contains a number of informational elements such as the following exemplary programme record shows:

| | |
|---|---|
| { | Ensemble ID (*) |
| | Service ID (*) |
| | Component ID (*) |
| | Programme Short ID (*) |
| | Programme Name |
| | Programme Description |
| | Start Time (*) |
| | End Time (*) |
| | Version |
| } | |

The parser and subsequent meta data extraction and record generation processes do not in some embodiments retain all the meta data provided for each programme in the original electronic programme guide file which reduces the memory required on the mobile communications handset to store the electronic programme component records. For example, in the above programme record the short name or actual start and/or end time and genre information have been removed. Other information has been combined from the two separate files into a single record (for example, the short description from the advanced EPG with the rest of the data from the basic EPG). The ensemble, service, component and version information given at the top of each information file is repeated within each programme record to facilitate searching based on one or more of these characteristics.

In some embodiments of the invention, not all elements of the programme record are searchable, i.e., a record may not be indexed by all elements. Thus in the exemplary record above, those elements which are search indices are denoted by a (*). Five exemplary search templates for EPG generation are shown below:

| | |
|---|---|
| i) | {Ensemble ID, Service ID, Component ID} |
| ii) | {Ensemble ID, Service ID, Component ID, Programme Short ID} |
| iii) | {Ensemble ID, Service ID, Component ID, Start Time} |
| iv) | {Start Time} |
| v) | {End Time} |

As shown in FIG. 7, the parsing process thus enables extraction of certain data elements which are collated in the form of programme records, one record containing information for a single programme. Once the extracted data elements have been formatted into the appropriate programme record, they are stored in data store 46 (i.e., memory) which is accessible by the DAB application 12. Data store 46 comprises either memory dedicated for the electronic programme guide process or shares a memory resource with other applications running on the operation system of the mobile communications device.

The DAB application data store 46 is thus populated with a number of programme records from each file downloaded, each record comprising electronic programme guide information which is indexed by a plurality of predefined criteria, independently of whether the indexing information was provided for each file or for each programme within a file when the programme information was originally compiled prior to transmission to the DAB receiver.

As shown above, in one embodiment, a record index may be provided to locate channel and programme start time (as in each original received electronic programme guide MOT file provided by the streamed data from the DAB receiver circuit). This allows easy updates to programme information to be provided as each MOT file is received. If a programme component already has a data record associated with the same indices, the received data stream no longer processes that component and moves on to the next programme component of the received file. If a data record exists, but needs to be updated, the previous data record can simply be modified to update the relevant index information or overwritten in its entirety. If no data record exists for a programme component, then one is created. In this way, the electronic programme files are processed more efficiently, and only new information is written to data records in the data store.

In another embodiment, each data record is indexed by channel and a programme short identifier. This enables both basic and advanced programme information to be stored in the same database when received and merged prior to such information being requested by a user. If a user does request the advanced information, this is can then be presented much faster to the user, as it is already merged with the basic information. The indexing allows basic and advanced information to be received in any order and in different download sessions.

In another embodiment, each data record is indexed according to programme start time alone or programme end time alone. This allows rapid searching for all programmes, on any channel, available to watch at a certain time. It also allows old programmes to be rapidly deleted by setting a time-out rule, for example.

The configuration of the DAB receiver hardware module (a term used herein to refer to the DAB hardware circuitry) and the DAB application of the mobile communications device enables background updating of electronic programme guide data whenever the DAB receiver module is tuned to a multiplex. This enables the invention to address the inconvenience which results to a user of a conventional EPG enabled device, due to the amount of time that conventional EPG data takes to update which impacts how rapidly a conventional EPG can be rendered on a display. This delay in the generation of conventional EPG displays is additionally inconvenient to a user of a mobile communications device who wishes to conserve battery life.

In one embodiment of the invention, the DAB receiver hardware is arranged to provide a plurality of the sub-channels in a multiplex to the DAB application 14, to that the DAB receiver must output at least one data stream comprising the audio, video or other content service the user is consuming content from, as well as the electronic programme guide information. A multiplex includes sub-channels conveying electronic programme guide information from one or more channels in the multiplex for one or more of the bearer channels in the multiplex. The DAB application 14 is automatically configured to identify and process electronic programme guide for all bearer channels in a received multiplex (i.e., in any multiplex that the DAB receiver module is tuned to).

This allows a continuous download and processing of the EPG information files in the manner described hereinabove, regardless of which channel in the multiplex the user is viewing at any point. This enables the data store comprising the programme information records to be more rapidly populated and updated where appropriate with new information elements. The user can change the channel viewed, and if this is to another channel in the same multiplex, the download is uninterrupted. If the new channel is provided in another DAB multiplex, the EPG file download on the previous multiplex is interrupted and at some point in that file, a programme record in that EPG file download will not have been sufficiently processed to generate a full programme record. This means that if the user retunes to the previous multiplex, it is possible to discard any programme records or elements of programme records which are already known, and to only generate and/or update programme records with elements which are new or have updated elements and/or index element information.

As a result, effectively this means that the file processing will only continue in a downloaded electronic programme guide from the point it was interrupted (unless some of the previously downloaded programme components now require updating). The result is less processing is performed and power consumption on the mobile communications device is reduced.

In another embodiment of the invention, a DAB receiver hardware module comprises a plurality of DAB receiver circuits, each arranged to output a multiplex of sub-channels to the DAB application 14. This embodiment enables simultaneous reception of electronic programme guide information from a plurality of DAB multiplexes. In one embodiment, two DAB receiver circuits are provided, each of which provides a multiplex to the DAB application. The DAB application receives electronic programme guide information from one multiplex which contains a sub-channel bearing content consumed by the user and by selectively controlling which multiplex the other receiver circuit is tuned to, electronic programme guide information for all other received multiplexes can be obtained independently of the specific service and multiplex the user is concurrently consuming content from.

The DAB sub-channels convey video or audio or data components of a consumable service channel, also referred to herein as an “entertainment channel”. Those sub-channels which convey the consumable channels are referred to herein as “bearer” sub-channels, whereas sub-channels conveying data content such as the electronic programme data comprise components of a service channel but are not “bearer” sub-channels in this context.

The DAB protocol is one of many digital broadcasting protocols which can be used to implement the invention. Other digital broadcasting protocols which are capable of conveying EPG data in a file format in which meta-data is sequentially listed for broadcast programme content over a pre-determined duration have similar limitations to that described for the DAB protocol above. These alternative embodiments also have the limitation that for each service channel received; an entire EPG file must be downloaded and appropriately rendered to generate an EPG for that service channel. This creates similar problems to the problems described herein above when such EPGs are to be implemented on devices which have more limited resources available for memory, data processing and power consumption than conventional set-top box EPGs require for example.

The best mode of the invention relates to a distribution system employing the DAB protocol to broadcast digital television content. Other broadcasting schemes are well known in the art to also provide a distribution system for other forms of audio, video and data content. The DAB protocol enables the transmission of live broadcast material with video and audio components, audio content alone (i.e., radio service channels), as well as data channels (which may be interactive) and television and pay per view video downloads, and access to a “library” of archived downloadable audio/video content. In this way, the invention provides a means of viewing electronic programme guide data for a range of digitally broadcast content, including television, radio and data content, which may be live-broadcast or comprise broadcast archived content.

Particularly where live-broadcast content is provided, the timing information for the programme guide for the live-broadcast may change. Conventionally, to update the timing information rendered on the displayed EPG, an entire updated EPG file for the service channel providing the live broadcast would need to be downloaded and processed. The invention instead enables only the programme records which have changed as a result of the live-broadcast to be updated to show new information.

The invention provides a method of generating an EPG which involves “re-indexing”, i.e., which duplicates certain information indices so that instead of being provided on a per EPG file basis, the information is now directly associated with each individual programme record and stored multiple times. This is achieved by extracting the relevant programme information from the programme listing within the EPG file.

This increases the amount of memory required to retain the same information provided by each EPG file downloaded, and is counter to the technical prejudice which currently exists in this field to minimise the use of memory resources in devices such as mobile communications devices. The advantage gained is that the data structures stored reduce the processing power required to render a screen display of programme guide information which increases the rapidity with which a mobile device can generate a display of the same information which could be displayed by directly downloading an EPG.

The use of programmes having individual data records also facilitates the rapidity with which updated EPG information can be assimilated into the data store, by allowing rapid cross-checking to determine if a programme record has already been created, and if so, if the information elements within that record have changed or not. This allows the programme record creation process to bypass programme information for which a programme record already exists, if there is no change to the information elements for that record. This latter effect, in conjunction with the background download of EPG files also described hereinabove, allows EPG information to be more rapidly generated when a user requests information to be displayed. It also enables selective elements of the EPG to be rendered more rapidly than is possible using known techniques which required a plurality of EPG files to be processed, updated on a rolling basis, and rendered on a service by service basis. The EPG of the invention is always capable of generating a display, as it relies on local storage of informational elements whose data structure is such that the rendering process can be performed in a more computationally efficient manner.

The term communications device, host communications device, mobile communications device and host mobile communications devices are terms used equivalently to refer to any device which has the required resources which a digital broadcast television receiver needs to function properly in the manner required by the invention. A all (host) mobile devices are considered to have limited internal power and are constrained in size and as such as are essentially either portable devices or devices fitted to moveable objects such as vehicles etc. Whilst some portable devices are capable of establishing bi-directional communications links within a mobile communications network, including devices capable of establishing both telephony and data communications over a mobile communications network, such as a mobile telephone handset, other portable devices may not have integrated communications capability. Such mobile devices are only intermittently mobile communications devices, in that they have an intermittent uni- or bi-directional communications capability. In this way, for example, in one embodiment of the invention, a media player is provided with the ability to dock into another device, and uses the other device to communicate with the remote server 90 in the manner shown in FIGS. 6c. This enables, for example, portable media players (including key “fob” type devices having wired or wireless interfaces with their host devices) to be reconfigured remotely to play digitally broadcast signals, or even to play stored content originating from a digitally broadcast signal, but encoded in a way which would otherwise not be playable on the device (i.e., the signal can only be played if one or more software components of the digital media player are upgraded).

Communication links established between the server providing DAB application components for download and the request generating and/or download receiving device may be uni-directional or bi-directional, wireless or fixed. Similarly, communication links between the receiving/request generating other device and the mobile communications device may be wireless and/or wireline and uni- or bi-directional. For example, in one embodiment a GPRS data connection is established between the mobile communications device 10 and the server 82 and a wired or wireless broadband connection is used to download the DAB application components to the other device 10. The DAB applications are then transferred to the mobile communications device over a wired (e.g. USB type connection) or a wireless (e.g. a Bluetooth™) connection. The DAB application is supported by the operating system of a mobile communications device and in operation, the DAB application will utilise resources shared with other applications running on the mobile communications device operating system. In one embodiment of the invention, the DAB application 14 controls the output of the DAB receiver only at the multiplex level and selection of individual services requires the operation of the DAB application 14 to be controlled by a user to enable the mobile communications device 10 to receive and play DAB radio and television signals. In another embodiment, the DAB receiver circuitry 12 may function automatically to provide data on a sub-channel of a multiplex in the background to the DAB receiver application 14 whilst one or more other sub-channels on the multiplex are being processed by the DAB receiver application 14 for play and/or display to a user using the resources of the mobile communications device. In one embodiment the DAB receiver application 12 is automatically activated by activation of the mobile communications device 10, however in other embodiments, the activation of the DAB application 12 may be selectively controlled by a user.

As mentioned above, the DAB receiver is at least in part provided in software which can be remotely configured/re-configured. This may be done by a server for the radio and/or television service pushing out a new version of the software required to activate or update the DAB application to the mobile communications device. Alternatively, the user of the mobile communications device may request to check to see if an update is available for the DAB application. In another embodiment of the invention, if the current DAB application receives data having a format which is not recognised, it will automatically initiate a request to an update server to determine if an update or new version of the existing DAB application is available for download. If a mobile communications device determines it cannot process a received signal (e.g. it cannot play/display the received audio/data/video content) or that the received signal contains to many errors, the operating system of the device may launch a self-diagnostic programme which runs to determine what software components are needed to rectify the fault. These software components can then be specified directly to the remote server in the request generated by the mobile communications device (or proxy therefore).

The DAB application 14 is capable of interfacing with the DAB receiver hardware 12 via interface 16 (16a,16b) which does not need to comprise the same interface means to exchange signalling and control information (16b) in all embodiments of the invention. Any implementation of a software modification to the DAB application 14 may be automatic when the new data is downloaded and controlled by the mobile communications operating system, or it may require the user to initiate acceptance of the downloaded file and to trigger installation of the file in an appropriate manner using user interface 32.

The above description indicates the best mode of the invention currently contemplated by the inventors, and those of ordinary skill in the art will be aware of obvious modifications and equivalent alternative features to those described hereinabove, and accordingly, the scope of the invention is as set out by the accompanying claims construed with reference to the above description. For example, the requests generated may include specific details of the DAB components to be downloaded, or these may be determined in any appropriate manner known to those of ordinary skill in the art by the remote server receiving the request (or any proxy for the remote server) and be based on any of the attributes provided in the request. As another example in one embodiment, the software components are installed to provide a coded reconfiguration of hardware components of the receiver hardware, which enables received radio signals having different characteristics including physical characteristics to be decoded by the receiver such as the frequency, bandwidth, polarisation, modulation etc.

Thus the invention provides a receiver for digital broadcast television or any form of streamed content having a similar signal structure in which certain features are implemented in hardware and certain features are implemented in software. The features provided using software can be reconfigured and as such are provided in a way which enables the operating system of the host device for the receiver to automatically install downloaded components of the receiver software to reconfigure the software and/or hardware of the receiver. In addition, the specific remuxing/demuxing elements of the receiver according to the invention enables the radio to use an interface designed to take a single sub-channel as input to the host device to instead allow a plurality of sub-channels to be processed using receiver software supported by the host device.

The limitations of using a mobile communications device are for many overly restrictive and in practice, where such device may connect to other devices for recharging etc, it is also quite feasible for the software to be downloaded and reconfigured at that point. In addition, whilst reconfiguration information can be received simply to update the decoders so they can decode different EPG information and/or allow a user to view subscribed to premium channel content, the technical concepts involved enable other elements of the DAB receiver to be updated (including hardware where this is reconfigurable using coded components).

The text of the claims attached hereto are incorporated into the description by reference, and The text of the abstract repeated below is hereby incorporated into the description.

A method of provisioning a mobile communications device with a digital audio broadcast (DAB) application configured to run on the mobile communications device, the method comprising: generating a request for at least one component of the DAB application using a communications application of said mobile communications device; communicating the request over a bi-directional wireless communications network to a remote server; receiving the request at the remote server; processing the request to identify one or more DAB application components suitable for download to the mobile communications device; downloading said one or more DAB application components to the mobile communications device over said bi-directional wireless communications network; and installing said one or more DAB application components onto said mobile communications devices.

1. A method of provisioning a mobile communications device with a tuneable receiver for digitally broadcast signals, the receiver comprising receiver software and receiver hardware, the receiver software comprising software configuring the receiver hardware and software supported by an operating system of the mobile communications device and sharing resources with other applications supported by the operating system, the receiver being at least in part capable of being reconfigured using receiver software, method comprising:
determining that said mobile communications device cannot correctly process a broadcast signal;
generating a request for reconfiguration of the receiver to enable the receiver to correctly process said broadcast signal;
communicating the request over a communications link to a remote server;
receiving the request at the remote server;
processing the request to identify one or more receiver software components suitable for the mobile communications device;
downloading said one or more receiver software components; and
installing said one or more receiver software components onto said mobile communications device to provide said receiver on said mobile communications device with means to correctly processing said broadcast signal.

2. A method as claimed in claim 1, further comprising the steps of:
processing the received broadcast signal to selectively extract a plurality of partially decoded sub-channels;
selectively remultiplexing said partially decoded sub-channels using receiver hardware; and
providing a multiplex of selected sub-channels to said receiver software;
demultiplexing said remultiplexed partially decoded sub-channels; and
decoding the contents of said decoded sub-channels, to enable the content of a plurality of sub-channels of one or more digitally broadcast signals to be processed simultaneously by the receiver software using resources shared with other applications supported by the operating system of the mobile communications device.

3. A method as claimed in claim 1, wherein said receiver and/or said mobile communications device further comprises means to automatically perform said step of determining a received broadcast signal is not being correctly processed.

4. A method as claimed in claim 3, wherein said step of determining a received broadcast signal is not being correctly processed is determined from one or more quality criteria of the audio and/or video content carried by said broadcasts signal not being complied with.

5. A method as claimed in claim 1, wherein a server performs said step of determining said mobile communications device cannot correctly process a broadcast signal, and said server generates said request for reconfiguration of the receiver, and said request for reconfiguration of the receiver contains an identifier for the mobile communications device and/or the type of receiver.

6. A method as claimed in claim 5, wherein said server generating said request for reconfiguration communicates said request to said remote platform arranged to identify said one or more receiver components.

7. A method as claimed in claim 5, wherein said server performing the step of determining the mobile communications device cannot correctly process a broadcast signal generates said request virtually and also performs said step of processing said request to identify one or more receiver software components suitable for said mobile communications device and wherein said request comprises an internal processing request.

8. A method as claimed in claim 1, wherein said receiver is arranged to share a resource with at least one other application supported by the operating system of said mobile communications device, wherein said request provides an indication of said shared resource, and wherein said one or more installed received software components are identified by said remote server in dependence on said shared resource to maintain the usage of the shared resource by the receiver within a predetermined range.

9. A method as claimed in claim 8, wherein said predetermined range is included in said request.

10. A method as claimed in claim 8, wherein said predetermined range is determined in dependence on the type of resource.

11. A method as claimed in claim 8, wherein said predetermined range is determined in dependence on the type of mobile communications device.

12. A method as claimed in claim 8, wherein said predetermined range is determined dynamically by said mobile communications device when said request is generated.

13. A method as claimed in claim 1, wherein said receiver software components are downloaded and are processed in the background of the operating system whilst said receiver is processing a received broadcast signal and said mobile communications device is playing audio and/or video content from a received digitally broadcast signal.

14. A method as claimed in claim 1, wherein the step of generating said request reconfiguration of the receiver is triggered by an action performed by a user of the mobile communications device.

15. A method as claimed in claim 1, wherein said request is communicated to the remote server by the mobile communications device.

16. A method as claimed in claim 1, wherein said request is communicated to the remote server by another device.

17. A method as claimed in claim 1, wherein said downloading step downloads said one or more software components for receiving a digitally broadcast television service to said mobile communications device.

18. A method as claimed in claim 1, wherein said downloading step downloads said one or more receiver software components to said other device, said downloaded software components being arranged for installation on said mobile communications device when connected to said other device.

19. A method as claimed in claim 1, wherein said request provides an identifier for a user of another device and the mobile communications device and said method further comprises the step of:
determining said user is connected to a communications network via said other device;
determining if said mobile communications device is connected to said other device, and if not,
prompting said user to connect said mobile communications device to said other device; and
downloading said one or more receiver software components to said mobile communications device via network connection established by said other device.

20. A method as claimed in claim 19, wherein if said mobile communications device is connected to said other communications device, said step of downloading said one or more receiver software components to said mobile communications device automatically removes any temporary software associated with said receiver and/or said download on said other communications device.

21. A method as claimed in claim 1, wherein said digital broadcast receiver comprises a detachable digital television broadcast receiver device which is connectable by a user to a plurality of host devices including said mobile communications device via a universal serial bus type interface, and wherein said detachable television broadcast receiver device is arranged to interface with a plurality of resources of said plurality of host devices for the processing and play of audio and/or video content provided by a digital television broadcast signal.

22. A method as claimed in claim 21, wherein said plurality of resources comprises two or more of the following:
an audio output resource;
a video output resource;
a processing resource;
a memory resource;
an electrical power resource.

23. A method as claimed in claim 21, wherein said digital broadcast receiver device operates through said interface to control said plurality of resources without requiring software to be previously installed on any one of said other devices.

24. A method as claimed in claim 1, wherein said step of installing said one or more receiver software components modifies the decoding process provided by a decoder component of said receiver.

25. A method as claimed in claim 24, wherein said software implements said decoder by reconfiguring said receiver hardware.

26. A method as claimed in claim 24, wherein said modification to the decoding process enables said receiver to decode signals provided according to a different source data encoding or transport protocol than said receiver was configured to decode prior to installing said one or more downloaded receiver software components on said mobile communications device.

27. A method as claimed in claim 1, wherein said step of installing one or more receiver software components enables said mobile communication device to perform one or more of the following functions:
display signals of a higher definition than the definition displayed prior to said one or more downloaded receiver software components being installed on said mobile communications device; and/or
play a signal having a different codec to a codec playable prior to said step of installing said one or more downloaded receiver software component on said mobile communications device; and/or
implement a new conditional access scheme for receiving digitally broadcast signals.

28. A method as claimed in claim 1, wherein said method of installing one or more receiver software components further comprises connecting said mobile communications device to another device having the capability to establish said communications links with said server for requesting and forwarding downloaded receiver components to said mobile communications device, and wherein said mobile communications device sends said request and receives said downloaded receiver software components using the communications link between said other device and said server.

29. A method as claimed in claim 1, wherein said mobile communications device generates said request using a wireless communications link, and wherein said other device receives said downloaded receiver application components over a different communications link.

30. A method as claimed in claim 28, when said mobile communications device is connected to the other device subsequent to said other device receiving said downloaded receiver components.

31. A method as claimed in claim 26, wherein a device identity for the mobile communications device and a device identity for the other device is included in said request to said server.

32. A method of provisioning a mobile communications device with receiver software according to any previous claim, wherein said step of installing said one or more receiver software components on to said mobile communications device comprises:
configuring a digital audio broadcast (DAB) television receiver including one or more DAB television receiver software components to interface with said DAB television receiver hardware, thereby enabling said DAB receiver to simultaneously decode a plurality of audio and/or video content sub-channels output by said receiver hardware to said mobile communications device to enable said device to play audio and/or video and/or data content from a DAB television service channel which previously could not be played to a user of the mobile communications device in the manner intended by the DAB television service channel provider.

33. A method as claimed in claim 32, further comprising the steps of:
said request establishing an Internet supported web-browser session with said remote server over said wireless communications network, and
maintaining said web-browser session during said step of downloading said receiver software components.

34. A method as claimed in claim 32, further comprising the steps of:
said request establishing an initial Internet supported web-browser session with said remote server over said wireless communications network; and
terminating said initial web-browser session prior to said step of downloading said receiver software components, and
wherein said receiver software components are subsequently downloaded using either a file-transfer protocol from a remote site or in a new session associated with the same user identity as a user identity associated with the original session

35. A mobile communications device having a receiver for tuning to digitally broadcast television signals via wireless communications link, wherein the receiver comprises a plurality of software and reconfigurable hardware components arranged to output data including audio and/or video content from a received digitally broadcast signal to the mobile communications device, the receiver being arranged to be reconfigured using a method according to claim 1.

36. A mobile communications device as claimed in claim 35, comprising:
means to communicate said request for reconfiguration of said receiver over a bi-directional wireless communications network to a remote server;
means to download said one or more receiver software components to the mobile communications device over said bi-directional wireless communications network; and
means to install said one or more receiver software components onto said mobile communications device.

37. A server arranged in use to be accessible over a wireless communications network to a mobile communications device, the server being arranged to provision said mobile communications device with one or more software components for reconfiguring a receiver associated with said mobile communications device with means to receive a digital broadcast television signal, the server performing said step of identifying one or more receiver software components which when installed comprises said means for said receiver to correctly receive the digital broadcast television signal.

38. A server as claimed in claim 37, the server comprising:
means to receive a request generated by a mobile communications device which is communicated using a bi-directional wireless communications network;
means to process the request to identify one or more receiver software components suitable for download to the mobile communications device; and
means to generate a signal comprising data for downloading said one or more receiver software components to the mobile communications device over said bi-directional wireless communications network.

39. A signal arranged to convey data from a server as claimed in claim 37 to a mobile communications device as claimed in claim 36 or 37 over a wireless communications network, said signal comprising data for downloading said one or more receiver software components to the mobile communications device.

40. A digital receiver module for receiving digitally broadcast television signals, the module comprising receiver hardware arranged to be integrated into a mobile communications device and receiver software and comprising:
means for tuning and receiving a digitally broadcast signal comprising at least one multiplex of sub channels;
means for partially decoding a received multiplex to extract at least sub channel identifiers for a plurality of sub channels of said multiplex;
means to signal said received identifiers for said multiplex sub channels to a receiver application supported by an operating system of said mobile communications device; and
means to send said received sub channels to said receiver application;
wherein, said step of partial decoding said received multiplex is implemented by a decoder of said digital receiver module arranged to utilize resources shared with other applications supported by said operating system of said mobile communications device;
means to selectively remultiplex a sub-set of a plurality of sub-channels demultiplexed from a digitally broadcast signal by said digital broadcast television signal receiver circuitry,
wherein said step of sending said received sub-channels to said receiver application comprises sending said remultiplexed subset of sub-channels, and
wherein said receiver application comprises means to demultiplex said received subset of sub-channels.

41. A digital receiver module as claimed in claim 40, wherein the receiver hardware is arranged to be integrated into the mobile communications device by interfacing with said mobile communications device via a data interface.

42. A digital receiver module as claimed in claim 41, wherein said data interface comprises a universal serial bus port.

43. A receiver module as claimed in claim 40, wherein said shared resources comprise one or more of the following:
a shared random access memory resource;
a shared flash memory resource;
a shared dynamic memory resource;
a shared processor resource.

44. (canceled)

45. A mobile communications device comprising a receiver for digital television broadcast signals, the receiver comprising:
means to separate out sub channels in a received digitally broadcast time-division multiplexed television signal, at least two of said sub channels comprising audio and/or video content and at least one sub-channel comprising programme guide information, said
sub channels being provided as input to a plurality of decoding means,
wherein the decoding means decode the sub-channels to provide displayable/playable content through means provided on said mobile communications device; and
wherein said decoding means is reconfigurable to change the protocol of the video and/or audio content decoded.

46. A mobile communications device as claimed in claim 45, wherein said decoding means is remotely configurable.

47. A mobile communications device as claimed in claim 46, wherein said decoding means is reconfigurable remotely in an automated manner by an application running on said device.

48. A mobile communications device as claimed in claim 47, wherein said decoding means is reconfigurable in a user controllable manner.

49. (canceled)

50. A mobile communications device as claimed in claim 47, wherein said multiplex comprises a plurality of sub channels, at least two sub channels relating to the same type of content conforming to differing protocols.

51. A DAB television software application arranged to be provisioned for remote configuring on a mobile communications device using a method as claimed in claim 1, thereby enabling said mobile communications device to display a DAB television service channel.

52. A method of provisioning a mobile communications device with a digital audio broadcast (DAB) application configured to run on an operating system of the mobile communications device, the method comprising:
generating a request for at least one component of the DAB application, said request indicating an identifier for the requesting device capable of being associated with a user profile for a plurality of devices;
communicating the request over a communications link to a remote server;
receiving the request at the remote server;
processing the request to identify one or more DAB application components suitable for the mobile communications device;
downloading said one or more DAB application components to a device selected in accordance with a predetermined set of rules associated with said user profile; and
installing said one or more DAB application components onto said mobile communications device directly if selected, or if another device is selected downloading said one or more DAB application components to said other device, wherein said installation of said DAB application components occurs when said mobile communications device connects to said other device.

53. A method as claimed in claim 52, wherein the downloading server selects one or more DAB application components for download to said device based on information provided by an identifier for said mobile communications device which identifies what, if any, existing DAB application components are already installed on said mobile communications device.

54. A method as claimed in claim 52, wherein the request specifies the DAB application components which are to be downloaded.

55. A method as claimed in claim 52, wherein prior to said the step of installing said DAB application components, said mobile communications device determines what resources controlled by the operating system of the mobile communications device are required to complete the installation, and if not available, requests the operating system of the mobile communications device to reallocate resources utilized by other applications to enable said installation process to proceed.

56. A method as claimed in claim 52, wherein during said the step of installing said DAB application components, said mobile communications device determines what resources controlled by the operating system of the mobile communications device are required to complete the installation, and if not available, requests the operating system of the mobile communications device to reallocate resources utilized by other applications to enable said installation process to proceed.

57. A method as claimed in claim 55, wherein if sufficient resources are not made available following said request for more resources, the installation process is terminated.

58. A method as claimed in claim 55, wherein the user of the mobile communications device is alerted to one or more characteristics of the resource conflict between the installation process and other applications running on said operating system, and said alert is arranged to prompt the user to selectively terminate one or more other applications or the installation process.

59. A method as claimed in claim 1, wherein one DAB application component comprises a component related to a characteristic of an electronic programme guide for bearer content received by said DAB application from a DAB receiver module of said mobile communications device.

60. A mobile communications device comprising:
pre-installed receiver hardware for the reception of digitally broadcast signals, said receiver hardware being pre-installed in a form unable to play received signals on said communications device;
means to install one or more components of an application on said mobile communications device, the installed application enabling the play of a selected received signal on said mobile communications device;
means for determining that said received signal is not playable on said device;
means for generating a request for means to play said signal on said device, said means comprising one or more components of an application whose installation on said mobile communications device will enable said received signal to be played on said device;
means for receiving said one or more components; and
means for installing said one or more components on said mobile communications device,
whereby the installed application enables the play of said received said communications device.

61. A mobile communications device as claimed in claim 60, further comprising:
means to receive one or more additional components of an application, whereby said one or more additional components enable play of a received signal previously not playable on said mobile communications device.

62. A mobile communications device as claimed in claim 60, wherein the installed application activates and control said pre-installed receiver hardware to enable play of a selected signal.

63. A mobile communications device as claimed in claim 60, wherein said one or more components are provided by a remote server and are downloaded to said mobile communications device.

64. A method of enabling a mobile communications device to play a received signal, the mobile communications device comprising pre-installed receiver hardware for the reception of digitally broadcast signals, said receiver hardware being pre-installed in a form unable to play said received signal on said communications device, the method comprising:
determining that said received signal is not playable on said device;
generating a request for means to play said signal on said device, said means comprising one or more components of an application whose installation on said mobile communications device will enable said received signal to be played on said device;
receiving said one or more components;
installing said one or more components on said mobile communications device, whereby the installed application enables the play of said received said communications device.

65. A method as claimed in claim 64, wherein in said step of generating a request, said request is sent to a remote server which processes information provided in said request to determine which one or more components will enable said received signal to be played on said device.

66. A method as claimed in claim 64, wherein in said step of generating a request, said request is sent to a remote server containing an indication of which one or more components will enable said received signal to be played on said device.

67. A method as claimed in claim 1, wherein the remote server selects one or more software components for download to said device based on information provided by an identifier for said mobile communications device which identifies what, if any, existing components are already installed on said mobile communications device.

68. A method as claimed in claim 1, wherein the request specifies the receiver software components to be downloaded, and said remote server identifies said receiver software components from said request.

69. A method as claimed in claim 1 wherein prior to said the step of installing said software components, said mobile communications device determines what resources controlled by the operating system of the mobile communications device are required to complete the installation, and if not available, requests the operating system of the mobile communications device to reallocate resources utilised by other applications to enable said installation process to proceed.

70. A method as claimed in claim 1, wherein during said the step of installing said DAB application components, said mobile communications device determines what resources controlled by the operating system of the mobile communications device are required to complete the installation, and if not available, requests the operating system of the mobile communications device to reallocate resources utilized by other applications to enable said installation process to proceed.

71. A method as claimed in claim 69, wherein if sufficient resources are not made available following said request for more resources, the installation process is terminated.

72. A method as claimed in claim 69, wherein the user of the mobile communications device is alerted to one or more characteristics of the resource conflict between the installation process and other applications running on said operating system, and said alert is arranged to prompt the user to selectively terminate one or more other applications or the installation process.

73. A method as claimed in claim 1, wherein one software component comprises a component related to a characteristic of an electronic programme guide for bearer content received by a software component of said receiver which is provided by a hardware component of said receiver receiving a digitally broadcast television signal.

74. A method of reconfiguring a mobile communications device having a receiver components arranged to receive a digitally broadcast signal in a communications network, the receiver components comprising components implemented using hardware and components implemented using software and arranged to share one or more resources of the communications device with at least one other component of the communications device, the method comprising:
determining that at least one element of a digitally broadcast signal is not capable of being correctly processed when received by a component of the communications device;
sending a request over a communications network to a remote server for means to enable said communications device to process said received signal correctly;
providing a signal containing means to process said at least one element of said received signal correctly to said mobile communications device;
processing said received signal providing said means to reconfigure said receiver to process said at least one element of said digitally broadcast signal correctly.

75. A method as claimed in claim 74, wherein said request comprises:
an identifier to enable said remote server to identify the type of mobile communications device.

76. A method as claimed in claim 74, wherein said request comprises:
an identifier to enable said remote server to identify a type of receiver of the mobile communications device.

77. A method as claimed in claim 74, wherein said request comprises:
an identifier to enable said remote server to identify a type of component of a receiver of the mobile communications device.

78. A method as claimed in claim 74, wherein said request comprises:
an identifier to enable said remote server to identify a type of resource of said mobile communications device shared by said receiver with other components of said mobile communications device.

79. A method as claimed in claim 74, wherein said request comprises:
an identifier to enable said remote server to identify a type of component of said mobile communications device which shares a resource with said receiver.

80. A method as claimed in claim 74, wherein the mobile communications device generates the request when the communications device determines that at least one element of a received digitally broadcast signal is not capable of being correctly processed by a component of the communications device.

81. A method as claimed in claim 74, wherein a remote server generates the request for the communications device when the remote server determines that at least one element of said digitally broadcast signal is not capable of being correctly processed by a component of the communications device.

82. A method as claimed in claim 74, wherein said method further comprises the steps of:
generating diagnostic data to diagnose why said at least one element of the received digitally broadcast signal is not being correctly processed by said mobile communications device.

83. A method as claimed in claim 82, wherein said method further comprises:
determining from said diagnostic data the means which will enable said communications device to process said received signal correctly.

84. A method as claimed in claim 83, wherein said diagnostic data is generated by said mobile communications device and is included in said request for said means.

85. A method as claimed in claim 82, wherein said diagnostic data indicates correct processing of said received signal is dependent on the amount of said at least one shared resources which is accessible by said receiver with another component of said mobile communications device.

86. A method as claimed in claim 85, wherein said means to reconfigure said receiver to process said at least one element of said digitally broadcasts signal correctly comprises a control signal which reconfigures said mobile communications device to increase the share of at least one shared resource available for use by said receiver and to decrease the share of said resource available to another component of said communications device.

87. A method as claimed in claim 74, wherein said a resource shared by said receiver with at least one other component of said mobile communications device comprises:
access to an interface to an operating system of said mobile communications device.

88. A method as claimed in claim 74, wherein said a resource shared by said receiver with at least one other component of said mobile communications device comprises one or more of the following:
a power resource;
a computer processing resource; and/or
a memory resource.

89. A method as claimed in claim 74, wherein said means comprises data which when received by said mobile communications device is processed by said device to reconfigure a software component of said mobile communications device to process said at least one element of said digitally broadcast signal correctly.

90. A method as claimed in claim 89, wherein said receiver comprises hardware and software components, and said means comprises data which when processed by said mobile communications device automatically reconfigures at least one of receiver component to correctly process said at least one element of said digitally broadcast signal.

91. A method as claimed in claim 74, further comprising the steps of:
determining the location of the mobile communications device,
wherein said means comprises data which is received by said mobile communications device in dependence on the location of the mobile communications device supporting data reception via a high-bandwidth communications link.

92. A method as claimed in claim 74, wherein said means comprises data which is stored at a proxy location until said mobile communications device is in said location supporting data reception via a high-bandwidth communications link.

93. A method as claimed in claim 74, wherein until said communications device receives said means, said communications device is configured to display a notice to alert the user to the need to obtain said means and requesting the user to move to a location in which the means can be received by the communications device.

94. A method as claimed in claim 74, wherein the processing of the received signal incorrectly provides in one or more of the following:
output not enabling audio content of the signal to be played by the mobile communications device;
output not enabling video content of the signal to be played correctly; and/or output not enabling textual content of the signal to be displayed correctly.

95. A method as claimed in claim 74, wherein a user of the communications device determines that said received signal is not being properly processed due to the quality of a played audio signal and said user operates said communications device to request said means to enable said communications device to process said received signal correctly.

96. A method as claimed in claim 95, wherein when said user operates said communications device to generate said request, said communications device automatically generates said diagnostic data for inclusion with said request.

97. A method as claimed in claim 74, wherein when said communications device determines an element of a received signal is not being processed correctly, the receiver of said communications device interfaces via the operating system of said communications device with said at least one shared resource to cause any other component of said communications device to reduce its usage of said shared resource.

98. A method of enabling a mobile communications device to correctly process at least one element of a received digital signal, said at least one element of the digital signal having a configuration enabling processing by a suitably configured mobile communications device receiving the signal, wherein the receiving mobile communications device comprises a receiver comprising hardware and software which co-operate to enable said mobile communications device to receive digitally broadcast signals but wherein said hardware and/or software have a configuration which does not enable said mobile communications device to play said at least one element of said received digital signal, the method comprising:
remotely determining that at least one element of said received signal is not being processed correctly by said receiving communications device;
generating a request for means to enable said receiving communications device to process said signal correctly, said means comprising one or more components of an application comprising computer program code, the computer program code being arranged to be installable on said mobile communications device, whereby when said received computer code is installed on said mobile communications device, said mobile communications device is able to correctly process said at least one element of said received signal;
sending said request to a remote server arranged to process the received request and to determine said one or more components of said application whose installation on said mobile communications device will enable said at least one element of said received signal to be processed correctly;
receiving a signal containing said one or more components determined by said remote server; and
installing said one or more components on said mobile communications device, whereby once installed, said receiver hardware and software able to correctly process said at east one element of said received signal.
